(19) United States
(12) Patent Application Publication
(10) Pub. No.: US 2013/0088144 A1
(43) Pub. Date: Apr. 11, 2013

(54) Phosphorescent Iridium Metal Complex, Light-Emitting Element, Light-Emitting Device, Electronic Appliance, and Lighting Device

(71) Applicant: Semiconductor Energy Laboratory Co., Ltd., Kanagawa-ken (JP)

(72) Inventors: Hideko Inoue, Atsugi (JP); Tomoya YAMAGUCHI, Atsugi (JP); Hiromi SEO, Sagamihara (JP); Satoshi SEO, Sagamihara (JP)

(73) Assignee: Semiconductor Energy Laboratory Co., Ltd., Kanagawa-ken (JP)

(21) Appl. No.: 13/644,106

(22) Filed: Oct. 3, 2012

(30) Foreign Application Priority Data
Oct. 6, 2011 (JP) 2011-222024

(51) Int. Cl. C07F 15/00; H05B 33/14

(52) U.S. Cl. CPC C07F 15/00; H05B 33/14
USPC 313/504; 544/225

(57) ABSTRACT

Provided is a light-emitting element including a phosphorescent iridium metal complex that emits phosphorescence in a yellow green to orange wavelength range, and has high emission efficiency and reliability. Thus, further provided is the phosphorescent iridium metal complex that emits phosphorescence in the yellow green to orange wavelength range. Further provided are a light-emitting device, an electronic appliance, and a lighting device each of which includes the above light-emitting element. The light-emitting element includes an EL layer between a pair of electrodes, and the EL layer contains a phosphorescent iridium metal complex where nitrogen at the 3-position of a pyrimidine ring having an aryl group bonded to the 4-position is coordinated to a metal, a substituent having a carbazole skeleton is bonded to the 6-position of the pyrimidine ring, and the aryl group bonded to the 4-position of the pyrimidine ring is ortho-metalated by being bonded to the metal.

### BACKGROUND OF THE INVENTION

1. Field of the Invention

The present invention relates to a phosphorescent iridium metal complex, a light-emitting element, a light-emitting device, an electronic appliance, and a lighting device.

2. Description of the Related Art

In recent years, research and development have been extensively conducted on light-emitting elements using electroluminescence (EL). In a basic structure of such a light-emitting element, a layer containing a light-emitting material is interposed between a pair of electrodes. By applying voltage to this element, light emission from the light-emitting material can be obtained.

Since such a light-emitting element is of self-light-emitting type, it is considered that the light-emitting element has advantages over a liquid crystal display in that visibility of pixels is high, backlight is not required, and so on and is therefore suitable as flat panel display elements. Besides, such a light-emitting element has advantages in that it can be formed to be thin and lightweight, and has quite fast response speed.

Furthermore, such a light-emitting element can be formed in a film form, and thus enables planar light emission. Therefore, a large-area element can be easily formed. This is a feature which is difficult to be obtained by point light sources typified by an incandescent lamp and an LED or linear light sources typified by a fluorescent lamp. Accordingly, the light-emitting element is extremely effective for use as a surface light source applicable to illumination and the like.

The light-emitting element utilizing electroluminescence can be broadly classified according to whether a light-emitting material is an organic compound or an inorganic compound. In the case of an organic EL element in which a layer containing an organic compound used as a light-emitting material is provided between a pair of electrodes, application of voltage to the light-emitting element causes injection of electrons from a cathode and holes from an anode into the layer containing the organic compound having a light-emitting property and thus current flows. The injected electrons and holes then lead the organic compound to its excited state, so that light emission is obtained from the excited organic compound.

The excited state generated by an organic compound can be a singlet excited state or a triplet excited state, and luminescence from the singlet excited state (S*) is referred to as fluorescence, and luminescence from the triplet excited state (T*) is referred to as phosphorescence. In addition, the statistical generation ratio thereof in a light-emitting element is considered to be S*:T*=1:3.

With a compound that can convert energy of a singlet excited state into light emission (hereinafter called a fluorescent compound), only light emission from the singlet excited state (fluorescence) is observed and that from the triplet excited state (phosphorescence) is not observed, at room temperature. Accordingly, the internal quantum efficiency (the ratio of generated photons to injected carriers) in a light-emitting element using a fluorescent compound is assumed to have a theoretical limit of 25% based on S*:T*=1:3.

In contrast, with a compound that can convert energy of a triplet excited state into light emission (hereinafter called a phosphorescent compound), light emission from the triplet excited state (phosphorescence) is observed. Further, since intersystem crossing (i.e., transition from a singlet excited state to a triplet excited state) easily occurs in a phosphorescent compound, the internal quantum efficiency can be theoretically increased to 100%. In other words, higher emission efficiency can be obtained than using a fluorescent compound. For these reasons, in order to achieve a highly efficient light-emitting element, a light-emitting element using a phosphorescent compound has been actively developed recently.

When a light-emitting layer of a light-emitting element is formed using a phosphorescent compound described above, in order to suppress concentration quenching or quenching due to triplet-triplet annihilation of the phosphorescent compound, the light-emitting layer is often formed such that the phosphorescent compound is dispersed in a matrix of another compound. Here, the compound as the matrix is called a host material, and the compound dispersed in the matrix, such as a phosphorescent compound, is called a guest material (dopant).

Further, a light-emitting element is disclosed which uses a light-emitting layer containing an organic low molecular hole-transport substance and an organic low molecular electron-transport substance as host materials and a phosphorescent compound as a dopant and has an improved lifetime and emission efficiency (for example, see Patent Document 1).

As the guest material (dopant), organometallic complexes having iridium (Ir) or the like as a central metal have attracted attention because of their high phosphorescence quantum yield. As the phosphorescent organometallic complex having iridium as the central metal (hereinafter called a phosphorescent iridium metal complex), for example, a phosphorescent iridium metal complex in which main ligands are a carbazole-substituted pyridine derivative and a phenyl derivative is disclosed (for example, see Patent Document 2).

### REFERENCE

### Patent Documents

[Patent Document 1] Japanese Translation or PCT International Application No. 2004-515895
[Patent Document 2] Japanese Translation of PCT International Application No. 2011-506312

### SUMMARY OF THE INVENTION

As reported in Patent Document 2, guest materials for phosphorescent compounds are being developed actively. However, light-emitting elements still need to be improved in terms of emission efficiency, reliability, emission characteristics, synthesis efficiency, and cost, and more excellent light-emitting elements are expected to be developed.

In view of the above problems, an object of one embodiment of the present invention is to provide a light-emitting element including a phosphorescent iridium metal complex. The phosphorescent iridium metal complex emits phosphorescence in a yellow green to orange wavelength range, and has high emission efficiency and reliability. Thus, another object of one embodiment of the present invention is to provide the phosphorescent iridium metal complex that emits phosphorescence in the yellow green to orange wavelength range.

Another object of one embodiment of the present invention is to provide a light-emitting device, an electronic appliance, and a lighting device each of which includes the above light-emitting element.

One embodiment of the present invention is a light-emitting element including an EL layer between a pair of electrodes, and the EL layer contains a phosphorescent iridium metal complex. In the phosphorescent iridium metal complex, nitrogen at the 3-position of a pyrimidine ring having an aryl group bonded to the 4-position is coordinated to a metal, a substituent having a carbazole skeleton is bonded to the 6-position of the pyrimidine ring, and the aryl group bonded to the 4-position of the pyrimidine ring is ortho-metalated by being bonded to the metal.

In the above structure, the phosphorescent iridium metal complex includes a structure represented by a general formula (G1-1).

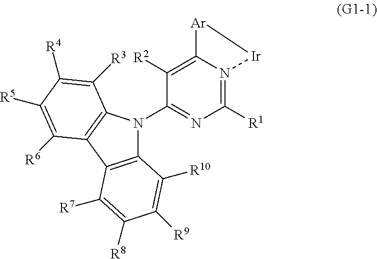

In the above structure, the phosphorescent iridium metal complex can be represented by a general formula (G1-2). Note that the phosphorescent iridium metal complex represented by the general formula (G1-2) is another embodiment of the present invention.

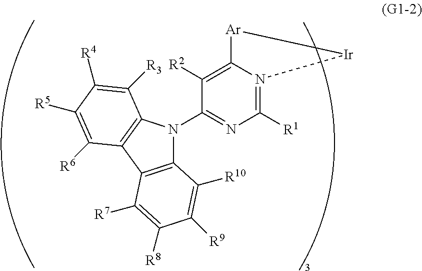

In the above structure, the phosphorescent iridium metal complex can be represented by a general formula (G1-3). Note that the phosphorescent iridium metal complex represented by the general formula (G1-3) is another embodiment of the present invention.

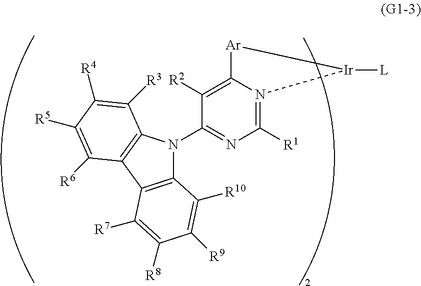

In the general formulas (G1-1), (G1-2), and (G1-3), Ar represents a substituted or unsubstituted arylene group having 6 to 13 carbon atoms. R¹ and R² separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group. In the general formula (G1-3), L represents a monoanionic ligand.

Note that the phosphorescent iridium metal complex including the structure represented by the general formula (G1-1) can emit phosphorescence and thus can be advantageously applied to a light-emitting layer of a light-emitting element. In particular, a phosphorescent iridium metal complex which includes the structure represented by the general formula (G1-1) and in which the lowest triplet excited state is formed in the structure is preferable because the phosphorescent iridium metal complex can efficiently emit phosphorescence.

In the above structure, the phosphorescent iridium metal complex can be represented by a structural formula (100). Note that the phosphorescent iridium metal complex represented by the structural formula (100) is another embodiment of the present invention.

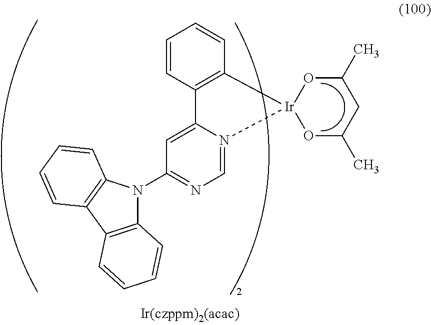

Another embodiment of the present invention is a light-emitting element including an EL layer between a pair of electrodes, and the EL layer contains a phosphorescent iridium metal complex. In the phosphorescent iridium metal complex, nitrogen at the 1-position of a pyrimidine ring having an aryl group bonded to the 2-position is coordinated to a metal, a substituent having a carbazole skeleton is bonded to the 4-position of the pyrimidine ring, and the aryl group bonded to the 2-position of the pyrimidine ring is ortho-metalated by being bonded to the metal.

In the above structure, the phosphorescent iridium metal complex includes a structure represented by a general formula (G2-1).

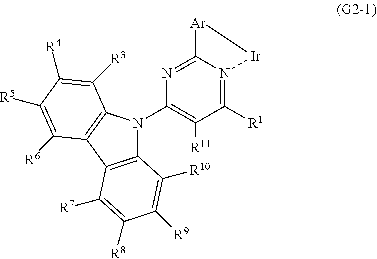

In the above structure, the phosphorescent iridium metal complex can be represented by a general formula (G2-2). Note that the phosphorescent iridium metal complex represented by the general formula (G2-2) is another embodiment of the present invention.

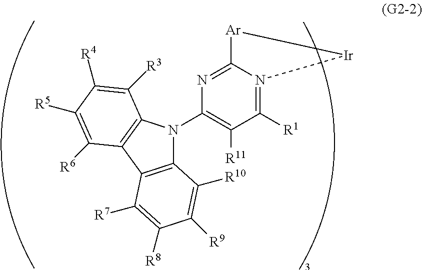

In the above structure, the phosphorescent iridium metal complex can be represented by a general formula (G2-3). Note that the phosphorescent iridium metal complex represented by the general formula (G2-3) is another embodiment of the present invention,

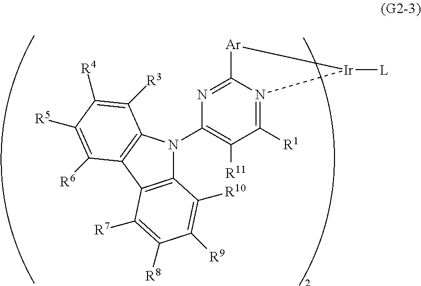

In the general formulas (G2-1), (G2-2), and (G2-3), Ar represents a substituted or unsubstituted arylene group having 6 to 13 carbon atoms. R¹ and R¹¹ separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group. In the general formula (G2-3), L represents a monoanionic ligand.

Note that the phosphorescent iridium metal complex including the structure represented by the general formula (G2-1) can emit phosphorescence and thus can be advantageously applied to a light-emitting layer of a light-emitting element. In particular, a phosphorescent iridium metal complex which includes the structure represented by the general formula (G2-1) and in which the lowest triplet excited state is formed in the structure is preferable because the phosphorescent iridium metal complex can efficiently emit phosphorescence.

In the phosphorescent iridium metal complex represented by any of the general formulas (G1-1) to (G1-3) and (G2-1) to (G2-3), iridium and a ligand have metal-carbon bonding, and accordingly charge is easily transferred to the pyrimidine ring, which is the ligand (that is, metal to ligand charge transfer (MLCT) transition easily occurs). The high possibility of MLCT transition promotes phosphorescence, which is a forbidden transition, and further, a triplet excitation life becomes shorter and the emission efficiency of the phosphorescent iridium metal complex is increased.

Another embodiment of the present invention is a light-emitting element including an EL layer between a pair of electrodes, and the EL layer contains a phosphorescent iridium metal complex. In the phosphorescent iridium metal complex, nitrogen at the 1-position of a 1,3,5-triazine ring having an aryl group bonded to the 2-position is coordinated to a metal, a substituent having a carbazole skeleton is bonded to the 4-position of the 1,3,5-triazine ring, and the aryl group bonded to the 2-position of the 1,3,5-triazine ring is ortho-metalated by being bonded to the metal.

In the above structure, the phosphorescent iridium metal complex includes a structure represented by a general formula (G3-1).

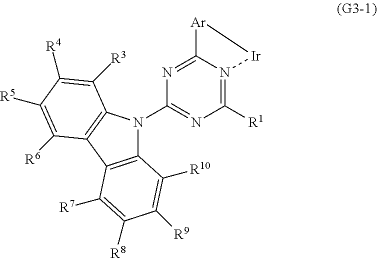

In the above structure, the phosphorescent iridium metal complex can be represented by a general formula (G3-2). Note that the phosphorescent iridium metal complex represented by the general formula (G3-2) is another embodiment of the present invention.

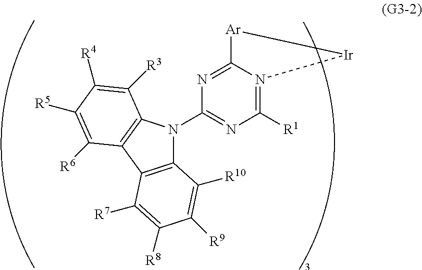

In the above structure, the phosphorescent iridium metal complex can be represented by a general formula (G3-3). Note that the phosphorescent iridium metal complex represented by the general formula (G3-3) is another embodiment of the present invention.

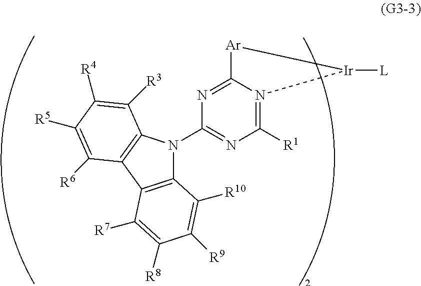

In the general formulas (G3-1), (G3-2), and (G3-3), Ar represents a substituted or unsubstituted arylene group having 6 to 13 carbon atoms. R¹ represents hydrogen or an alkyl group having 1 to 4 carbon atoms, and R³ to R¹⁰ separately represent hydrogen, an alkyl group having 1 to 4 carbon atoms, or a substituted or unsubstituted phenyl group. In the general formula (G3-3), L represents a monoanionic ligand.

Note that the phosphorescent iridium metal complex including the structure represented by the general formula (G3-1) can emit phosphorescence and thus can be advantageously applied to a light-emitting layer of a light-emitting element. In particular, a phosphorescent iridium metal complex which includes the structure represented by the general formula (G3-1) and in which the lowest triplet excited state is formed in the structure is preferable because the phosphorescent iridium metal complex can efficiently emit phosphorescence.

In the phosphorescent iridium metal complex represented by any of the general formulas (G3-1) to (G3-3), iridium and a ligand have metal-carbon bonding, and accordingly charge is easily transferred to the 1,3,5-triazine ring, which is the ligand (that is, MLCT transition easily occurs). The high possibility of MLCT transition promotes phosphorescence, which is a forbidden transition, and further, a triplet excitation life becomes shorter and the emission efficiency of the phosphorescent iridium metal complex is increased.

The phosphorescent iridium metal complex represented by any of the general formulas (G1-1) to (G1-3) has the substituent that has the carbazole skeleton and is bonded to the 6-position of the pyrimidine ring. The phosphorescent iridium metal complex represented by any of the general formulas (G2-1) to (G2-3) has the substituent that has the carbazole skeleton and is bonded to the 4-position of the pyrimidine ring. The phosphorescent iridium metal complex represented by any of the general formulas (G3-1) to (G3-3) has the substituent that has the carbazole skeleton and is bonded to the 4-position of the 1,3,5-triazine ring. Since the carbazole skeleton with an excellent hole-trapping property is thus bonded to the nitrogen-containing aromatic ring that influences the HOMO of the above ortho-metalated complex, an electrically stable substance as an EL material can be obtained.

A light-emitting device, an electronic appliance, and a lighting device each using the above light-emitting element also belong to the category of the present invention. Note that the light-emitting device in this specification includes an image display device, an illumination device, and a light source. In addition, the light-emitting device includes, in its category, all of a module in which a connector such as a flexible printed circuit (FPC), a tape automated bonding (TAB) tape or a tape carrier package (TCP) is connected to a panel, a module in which a printed wiring board is provided on the tip of a TAB tape or a TCP, and a module in which an integrated circuit (IC) is directly mounted on a light-emitting element by a chip on glass (COG) method.

One embodiment of the present invention can provide a light-emitting element including a phosphorescent iridium metal complex. The phosphorescent iridium metal complex emits phosphorescence in a yellow green to orange wavelength range, and has high emission efficiency and reliability. Thus, another embodiment of the present invention can provide the phosphorescent iridium metal complex that emits phosphorescence in the yellow green to orange wavelength range.

### BRIEF DESCRIPTION OF THE DRAWINGS

In the accompanying drawings:

FIG. 1 illustrates a light-emitting element according to one embodiment of the present invention;

FIG. 2 illustrates a light-emitting element according to one embodiment of the present invention;

FIGS. 3A and 3B illustrate light-emitting elements according to embodiments of the present invention;

FIG. 4 illustrates a light-emitting device according to one embodiment of the present invention;

FIGS. 5A and 5B illustrate a light-emitting device according to one embodiment of the present invention;

FIGS. 6A to 6D each illustrate an electronic appliance according to one embodiment of the present invention;

FIGS. 7A1, 7A2, 7A3, and 7B illustrate electronic appliances according to embodiments of the present invention;

FIGS. 8A to 8C each illustrate a lighting device according to one embodiment of the present invention;

FIG. 9 shows a ¹H-NMR chart of a phosphorescent iridium metal complex synthesized in Example 1;

FIG. 10 shows an ultraviolet-visible absorption spectrum and an emission spectrum of a phosphorescent iridium metal complex [Ir(czppm)₂(acac)] according to one embodiment of the present invention in a dichloromethane solution;

FIG. 11 illustrates a light-emitting element of an Example;

FIG. 12 shows current density versus luminance characteristics of a light-emitting element 1;

FIG. 13 shows voltage versus luminance characteristics of the light-emitting element 1;

FIG. 14 shows luminance versus current efficiency characteristics of the light-emitting element 1;

FIG. 15 shows voltage versus current characteristics of the light-emitting element 1;

FIG. 16 shows luminance versus chromaticity coordinates characteristics of the light-emitting element 1;

FIG. 17 shows luminance versus power efficiency characteristics of the light-emitting element 1;

FIG. 18 shows an emission spectrum of the light-emitting element 1;

FIG. 19 shows time versus normalized luminance characteristics of the light-emitting element 1;

FIG. 20 shows time versus voltage characteristics of the light-emitting element 1; and

FIG. 21 shows the results of LC-MS measurement of [Ir(czppm)₂(acac)].

### DETAILED DESCRIPTION OF THE INVENTION

Hereinafter, embodiments of the present invention will be described in detail with reference to the drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments.

### Embodiment 1

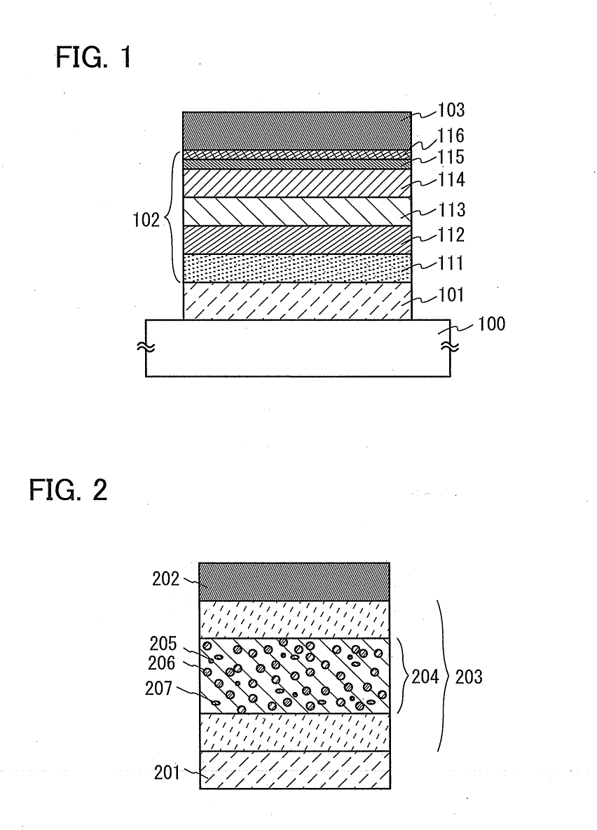

In this embodiment, a light-emitting element including, between a pair of electrodes, an EL layer that contains a phosphorescent iridium metal complex is described with reference to FIG. 1.

In a light-emitting element described in this embodiment, as illustrated in FIG. 1, an EL layer 102 including a light-emitting layer 113 is provided between a pair of electrodes (a first electrode 101 and a second electrode 103), and the EL layer 102 includes a hole-injection layer 111, a hole-transport layer 112, an electron-transport layer 114, an electron-injection layer 115, a charge-generation layer 116, and the like in addition to the light-emitting layer 113. Note that in this embodiment, the first electrode 101 is used as an anode and the second electrode 103 is used as a cathode. The first electrode 101 is formed over a substrate 100. Note that the light-emitting layer 113 contains a phosphorescent iridium metal complex according to one embodiment of the present invention.

By application of voltage to such a light-emitting element, holes injected from the first electrode 101 side and electrons injected from the second electrode 103 side recombine in the light-emitting layer 113 to raise the phosphorescent iridium metal complex contained in the light-emitting layer 113 to an excited state. Then, light is emitted when the phosphorescent iridium metal complex in the excited state relaxes to the ground state. Thus, in one embodiment of the present invention, the phosphorescent iridium metal complex functions as a light-emitting material in the light-emitting element.

The hole-injection layer 111 included in the EL layer 102 is a layer containing a substance with a high hole-transport property and an acceptor substance. When electrons are extracted from the substance with a high hole-transport property owing to the acceptor substance, holes are generated. Thus, holes are injected from the hole-injection layer 111 into the light-emitting layer 113 through the hole-transport layer 112.

The charge-generation layer 116 is a layer containing a substance with a high hole-transport property and an acceptor substance. Electrons are extracted from the substance with a high hole-transport property owing to the acceptor substance, and the extracted electrons are injected from the electron-injection layer 115 with an electron-injection property into the light-emitting layer 113 through the electron-transport layer 114.

The following shows a specific example in which the light-emitting element described in this embodiment is manufactured.

The substrate 100 is used as a support of the light-emitting element. The substrate 100 can be made of, for example, glass, quartz, plastic, or the like. Alternatively, the substrate 100 may be a flexible substrate. The flexible substrate is a substrate that can be bent, such as a plastic substrate made of polycarbonate, polyarylate, or polyether sulfone. Alternatively, a film (made of polypropylene, a polyester, poly(vinyl fluoride), poly(vinyl chloride), or the like), an inorganic film formed by evaporation, or the like can be used. Note that another material can be used as long as it can function as a support in a process of manufacturing the light-emitting element.

For the first electrode 101 and the second electrode 103, a metal, an alloy, an electrically conductive compound, a mixture thereof, and the like can be used. Specific examples include indium oxide-tin oxide (ITO: indium tin oxide), indium oxide-tin oxide containing silicon or silicon oxide, indium oxide-zinc oxide, indium oxide containing tungsten oxide and zinc oxide, gold (Au), platinum (Pt), nickel (Ni), tungsten (W), chromium (Cr), molybdenum (Mo), iron (Fe), cobalt (Co), copper (Cu), palladium (Pd), and titanium (Ti). Further, any of the following materials can be used: elements that belong to Group 1 or Group 2 of the periodic table, that is, alkali metals such as lithium (Li) and cesium (Cs) or alkaline earth metals such as calcium (Ca) and strontium (Sr), magnesium (Mg), and alloys containing at least one of the metal (e.g., Mg—Ag and Al—Li); rare earth metals such as europium (Eu) and ytterbium (Yb), and alloys containing at least one of the metal; graphene; and the like. The first electrode 101 and the second electrode 103 can be formed by, for example, a sputtering method, an evaporation method (including a vacuum evaporation method), or the like.

Examples of the substance with a high hole-transport property used for the hole-injection layer 111, the hole-transport layer 112, and the charge-generation layer 116 include the following: aromatic amine compounds such as 4,4′-bis[N-(1-naphthyl)-N-phenylamino]biphenyl (abbreviation: NPB or α-NPD), N,N′-bis(3-methylphenyl)-N,N′-diphenyl-[1,1′-biphenyl]-4,4′-diamine (abbreviation: TPD), 4,4′,4″-tris(carbazol-9-yl)triphenylamine (abbreviation: TCTA), 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), 4,4′-bis[N-(spiro-9,9′-bifluoren-2-yl)-N-phenylamino]biphenyl (abbreviation: BSPB), and 4-phenyl-4-(9-phenylfluoren-9-yl)triphenylamine (abbreviation: BPAFLP); 3-[N-(9-phenylcarbazol-3-yl)-N-phenylamino]-9-phenylcarbazole (abbreviation: PCzPCA1); 3,6-bis[N-(9-phenylcarbazol-3-yl)-N-phenylamino]-9-phenylcarbazole (abbreviation: PCzPCA2); 3-[N-(1-naphthyl)-N-(9-phenylcarbazol-3-yl)amino]-9-phenylcarbazole (abbreviation: PCzPCN1); and the like. Other examples include carbazole compounds such as 4,4′-di(N-carbazolyl)biphenyl (abbreviation: CBP), 1,3,5-tris[4-(N-carbazolyl)phenyl]benzene (abbreviation: TCPB), and 9-[4-(10-phenyl-9-anthracenyl)phenyl]-9H-carbazole (abbreviation: CzPA), dibenzothiophene compounds such as 1,3,5-tri(dibenzothiophen-4-yl)-benzene (abbreviation: DBT3P-II), dibenzofuran compounds such as 1,3,5-tri(dibenzofuran-4-yl)-benzene (abbreviation: DBF3P-II), and condensed-ring compounds such as 9-[3,5-di(phenanthren-9-yl)-phenyl]-phenanthrene (abbreviation: Pn3P). The substances mentioned here are mainly ones that have a hole mobility of 10⁻⁶ cm²/V·s or higher. Note that any substance other than the above substances may be used as long as it is a substance in which the hole-transport property is higher than the electron-transport property.

Further, a high molecular compound such as poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacrylamide] (abbreviation: PTPDMA), or poly[N,N′-bis(4-butylphenyl)-N,N′-bis(phenyl)benzidine] (abbreviation: Poly-TPD) can be used.

As each of the hole-injection layer 111 and the charge-generation layer 116, a layer in which any of the above substances with high hole-transport properties and a substance with an acceptor property are mixed may be used, in which case a favorable carrier-injection property is obtained. As the substance with an acceptor property to be used, a transition metal oxide and an oxide of a metal belonging to any one of Groups 4 to 8 of the periodic table can be given. Specifically, molybdenum oxide is particularly preferable.

The light-emitting layer 113 contains a phosphorescent iridium metal complex as a guest material serving as a light-emitting material, and a substance having higher triplet excitation energy than the phosphorescent iridium metal complex as a host material.

Preferable examples of the host material include compounds having an arylamine skeleton, such as 2,3-bis(4-diphenylaminophenyl)quinoxaline (abbreviation: TPAQn) and NPB, carbazole derivatives such as CBP and 4,4′,4″-tris(N-carbazolyl)triphenylamine (abbreviation: TCTA), and metal complexes such as bis[2-(2-hydroxyphenyl)pyridinato]zinc (abbreviation: Znpp₂), bis[2-(2-hydroxyphenyl)benzoxazolato]zinc (abbreviation: Zn(BOX)_{y}), bis(2-methyl-8-quinolinolato)(4-phenylphenolato)aluminum (abbreviation: BAlq), and tris(8-quinolinolato)aluminum (abbreviation: Alq₃). Alternatively, a high molecular compound such as PVK can be used.

Note that the light-emitting layer 113 may contain plural kinds of host materials, such as the above host material and a material that is contained in the host-transport layer 112.

Here, the light-emitting layer 113 can contain, as the guest material, the phosphorescent iridium metal complex where nitrogen at the 3-position of a pyrimidine ring having an aryl group bonded to the 4-position is coordinated to a metal, a substituent having a carbazole skeleton is bonded to the 6-position of the pyrimidine ring, and the aryl group bonded to the 4-position of the pyrimidine ring is ortho-metalated by being bonded to the metal.

That is, the phosphorescent iridium metal complex includes the structure represented by the general formula (G1-1).

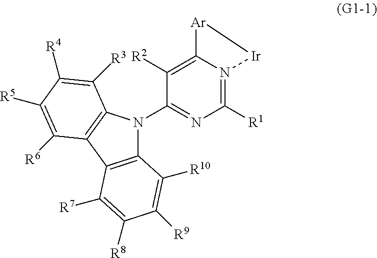

In the general formula (G1-1), Ar represents a substituted or unsubstituted arylene group having 6 to 13 carbon atoms. R¹ and R² separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group.

Note that the phosphorescent iridium metal complex including the structure represented by the general formula (G1-1) can emit phosphorescence and thus can be advantageously applied to a light-emitting layer of a light-emitting element. In particular, a phosphorescent iridium metal complex which includes the structure represented by the general formula (G1-1) and in which the lowest triplet excited state is formed in the structure is preferable because the phosphorescent iridium metal complex can efficiently emit phosphorescence. To obtain such a mode, another skeleton (another ligand) which is included in the phosphorescent iridium metal complex may be selected such that the lowest triplet excitation energy of the structure is equal to or lower than the lowest triplet excitation energy of the another skeleton (the another ligand), for example. In that case, regardless of what a skeleton (ligand) other than the structure is, the lowest triplet excited state is formed by the structure at last, so that phosphorescence originating from the structure is obtained. Therefore, phosphorescence can be highly efficiently obtained. A typical example is vinyl polymer having the structure as a side chain.

The phosphorescent iridium metal complex including the structure represented by the above general formula (G1-1) is specifically represented by the general formula (G1-2) or (G1-3). Further, structures represented by the general formulas (G1-2) and (G1-3) are each a phosphorescent iridium metal complex according to one embodiment of the present invention.

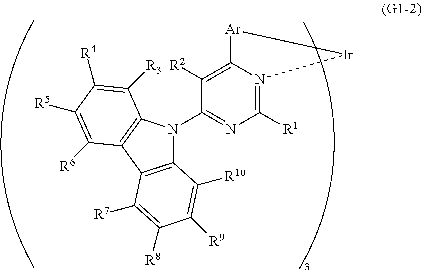

In the general formula (G1-2), Ar represents a substituted or unsubstituted arylene group having 6 to 13 carbon atoms. R¹ and R² separately represents hydrogen or an alkyl group having 1 to 4 carbon atoms, and R³ to R¹⁰ separately represent hydrogen, an alkyl group having 1 to 4 carbon atoms, or a substituted or unsubstituted phenyl group.

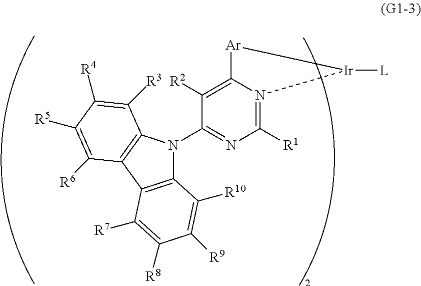

In the general formula (G1-3), Ar represents a substituted or unsubstituted arylene group having 6 to 13 carbon atoms. R¹ and R² separately represents hydrogen or an alkyl group having 1 to 4 carbon atoms, and R³ to R¹⁰ separately represent hydrogen, an alkyl group having 1 to 4 carbon atoms, or a substituted or unsubstituted phenyl group. Further, L represents a monoanionic ligand.

As the guest material, the phosphorescent iridium metal complex where nitrogen at the 1-position of a pyrimidine ring having an aryl group bonded to the 2-position is coordinated to a metal, a substituent having a carbazole skeleton is bonded to the 4-position of the pyrimidine ring, and the aryl group bonded to the 2-position of the pyrimidine ring is ortho-metalated by being bonded to the metal can be used.

That is, the phosphorescent iridium metal complex includes the structure represented by the general formula (G2-1).

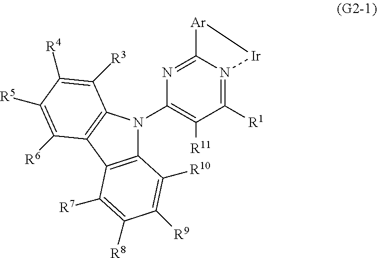

In the general formula (G2-1), Ar represents a substituted or unsubstituted arylene group having 6 to 13 carbon atoms. R¹ and R¹¹ separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group.

Note that the phosphorescent iridium metal complex including the structure represented by the general formula (G2-1) can emit phosphorescence and thus can be advantageously applied to a light-emitting layer of a light-emitting element. In particular, a phosphorescent iridium metal complex which includes the structure represented by the general formula (G2-1) and in which the lowest triplet excited state is formed in the structure is preferable because the phosphorescent iridium metal complex can efficiently emit phosphorescence. To obtain such a mode, another skeleton (another ligand) which is included in the phosphorescent iridium metal complex may be selected such that the lowest triplet excitation energy of the structure is equal to or lower than the lowest triplet excitation energy of the another skeleton (the another ligand), for example. In that case, regardless of what a skeleton (ligand) other than the structure is, the lowest triplet excited state is formed by the structure at last, so that phosphorescence originating from the structure is obtained. Therefore, phosphorescence can be highly efficiently obtained. A typical example is vinyl polymer having the structure as a side chain.

The phosphorescent iridium metal complex including the structure represented by the above general formula (G2-1) is specifically represented by the general formula (G2-2) or (G2-3). Further, structures represented by the general formulas (G2-2) and (G2-3) are each a phosphorescent iridium metal complex according to one embodiment of the present invention.

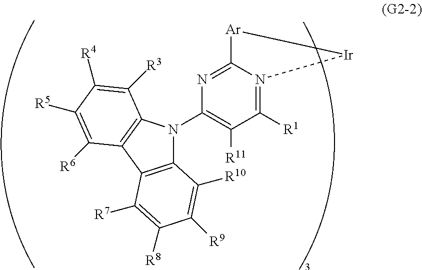

In the general formula (G2-2), Ar represents a substituted or unsubstituted arylene group having 6 to 13 carbon atoms. R¹ and R¹¹ separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group.

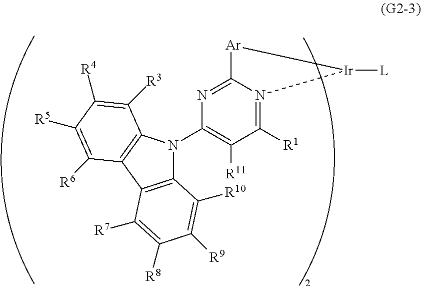

In the general formula (G2-3), Ar represents a substituted or unsubstituted arylene group having 6 to 13 carbon atoms. R¹ and R¹¹ separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group. Further, L represents a monoanionic ligand.

As the guest material, the phosphorescent iridium metal complex where nitrogen at the 1-position of a 1,3,5-triazine ring having an aryl group bonded to the 2-position is coordinated to a metal, a substituent having a carbazole skeleton is bonded to the 4-position of the 1,3,5-triazine ring, and the aryl group bonded to the 2-position of the 1,3,5-triazine ring is ortho-metalated by being bonded to the metal can be used.

That is, the phosphorescent iridium metal complex includes the structure represented by the general formula (G3-1).

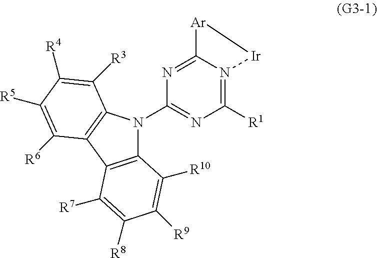

In the general formula (G3-1), Ar represents a substituted or unsubstituted arylene group having 6 to 13 carbon atoms. R¹ represents hydrogen or an alkyl group having 1 to 4 carbon atoms, and R³ to R¹⁰ separately represent hydrogen, an alkyl group having 1 to 4 carbon atoms, or a substituted or unsubstituted phenyl group.

Note that the phosphorescent iridium metal complex including the structure represented by the general formula (G3-1) can emit phosphorescence and thus can be advantageously applied to a light-emitting layer of a light-emitting element. In particular, a phosphorescent iridium metal complex which includes the structure represented by the general formula (G3-1) and in which the lowest triplet excited state is formed in the structure is preferable because the phosphorescent iridium metal complex can efficiently emit phosphorescence. To obtain such a mode, another skeleton (another ligand) which is included in the phosphorescent iridium metal complex may be selected such that the lowest triplet excitation energy of the structure is equal to or lower than the lowest triplet excitation energy of the another skeleton (the another ligand), for example. In that case, regardless of what a skeleton (ligand) other than the structure is, the lowest triplet excited state is formed by the structure at last, so that phosphorescence originating from the structure is obtained. Therefore, phosphorescence can be highly efficiently obtained. A typical example is vinyl polymer having the structure as a side chain.

The phosphorescent iridium metal complex including the structure represented by the above general formula (G3-1) is specifically represented by the general formula (G3-2) or (G3-3). Further, structures represented by the general formulas (G3-2) and (G3-3) are each a phosphorescent iridium metal complex according to one embodiment of the present invention.

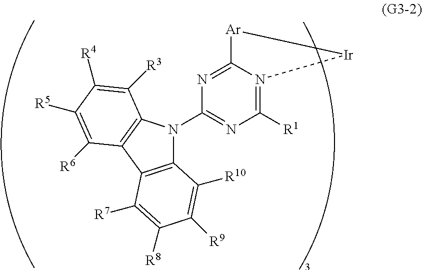

In the general formula (G3-2), Ar represents a substituted or unsubstituted arylene group having 6 to 13 carbon atoms. R¹ represents hydrogen or an alkyl group having 1 to 4 carbon atoms, and R³ to R¹⁰ separately represent hydrogen, an alkyl group having 1 to 4 carbon atoms, or a substituted or unsubstituted phenyl group.

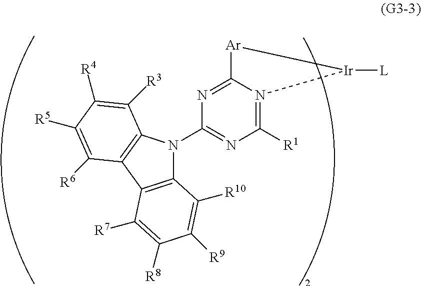

In the general formula (G3-3), Ar represents a substituted or unsubstituted arylene group having 6 to 13 carbon atoms. R¹ represents hydrogen or an alkyl group having 1 to 4 carbon atoms, and R³ to R¹⁰ separately represent hydrogen, an alkyl group having 1 to 4 carbon atoms, or a substituted or unsubstituted phenyl group. Further, L represents a monoanionic ligand.

In the phosphorescent iridium metal complex represented by any of the general formulas (G1-1) to (G2-3), iridium and a ligand have metal-carbon bonding, and accordingly charge is easily transferred to the pyrimidine ring, which is the ligand (that is, MLCT transition easily occurs). Further, in the phosphorescent iridium metal complex represented by any of the general formulas (G3-1) to (G3-3), iridium and a ligand have metal-carbon bonding, and accordingly charge is easily transferred to the 1,3,5-triazine ring, which is the ligand (that is, MLCT transition easily occurs). The high possibility of MLCT transition promotes forbidden transition such as phosphorescence, and further, a triplet excitation life becomes shorter and the emission efficiency of the phosphorescent iridium metal complex is increased.

The phosphorescent iridium metal complex represented by any of the above general formulas (G1-1) to (G3-3) has a bulky structure due to orthometalation by coordination of the iridium ion with the pyrimidine ring or the 1,3,5-triazine ring, and thus can prevent concentration quenching.

The phosphorescent iridium metal complex represented by any of the general formulas (G1-1) to (G1-3) has the substituent that has the carbazole skeleton and is bonded to the 6-position of the pyrimidine ring. The phosphorescent iridium metal complex represented by any of the general formulas (G2-1) to (G2-3) has the substituent that has the carbazole skeleton and is bonded to the 4-position of the pyrimidine ring. The phosphorescent iridium metal complex represented by any of the general formulas (G3-1) to (G3-3) has the substituent that has the carbazole skeleton and is bonded to the 4-position of the 1,3,5-triazine ring. Since the carbazole skeleton with an excellent hole-trapping property is thus bonded to the nitrogen-containing aromatic ring that influences the HOMO of the above ortho-metalated complex, an electrically stable substance as an EL material can be obtained.

Specific examples of Ar in the above general formulas (G1-1) to (G3-3) include a phenylene group, a phenylene group to which one or more alkyl groups are bonded, a phenylene group to which one or more alkoxy groups are bonded, a phenylene group to which one or more alkylthio groups are bonded, a phenylene group to which one or more haloalkyl groups are bonded, a phenylene group to which one or more halogen groups are bonded, a phenylene group to which one or more phenyl groups are bonded, a biphenyl-diyl group, a naphthalene-diyl group, a fluorene-diyl group, a 9,9-dialkylfluorene-diyl group, and a 9,9-diarylfluorene-diyl group.

Examples of a specific structure of the monoanionic ligand (L) in the above general formulas (G1-3), (G2-3), and (G3-3) include ligands represented by structural formulas (L1) to (L6).

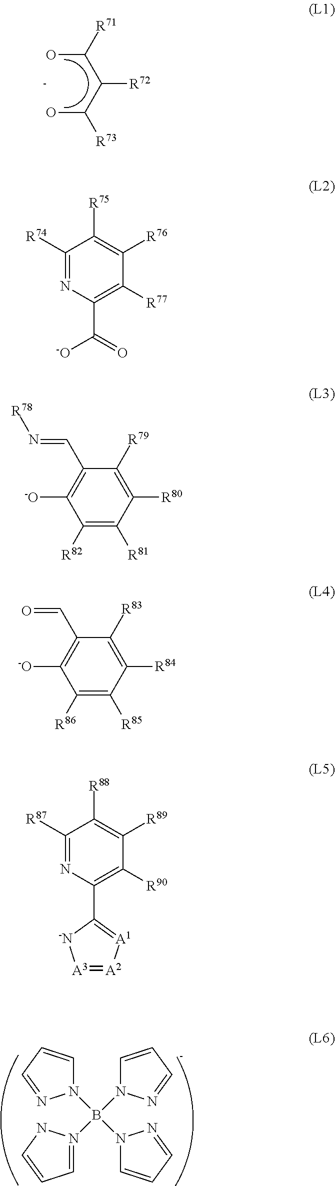

In the structural formulas (L1) to (L6), R⁷¹ to R⁹⁰ separately represent hydrogen, an alkyl group having 1 to 4 carbon atoms, a halogen group, a haloalkyl group, an alkoxy group having 1 to 4 carbon atoms, or an alkylthio group having 1 to 4 carbon atoms. In addition, A¹, A², and A³ separately represent nitrogen N or carbon C—R in which R is bonded to carbon. R represents hydrogen, an alkyl group having 1 to 4 carbon atoms, a halogen group, a haloalkyl group having 1 to 4 carbon atoms, or a phenyl group.

Examples of the phosphorescent iridium metal complex represented by any of the above general formulas (G1-1) to (G3-3) include phosphorescent iridium metal complexes represented by structural formulas (100) to (126). However, the present invention is not limited to these examples.

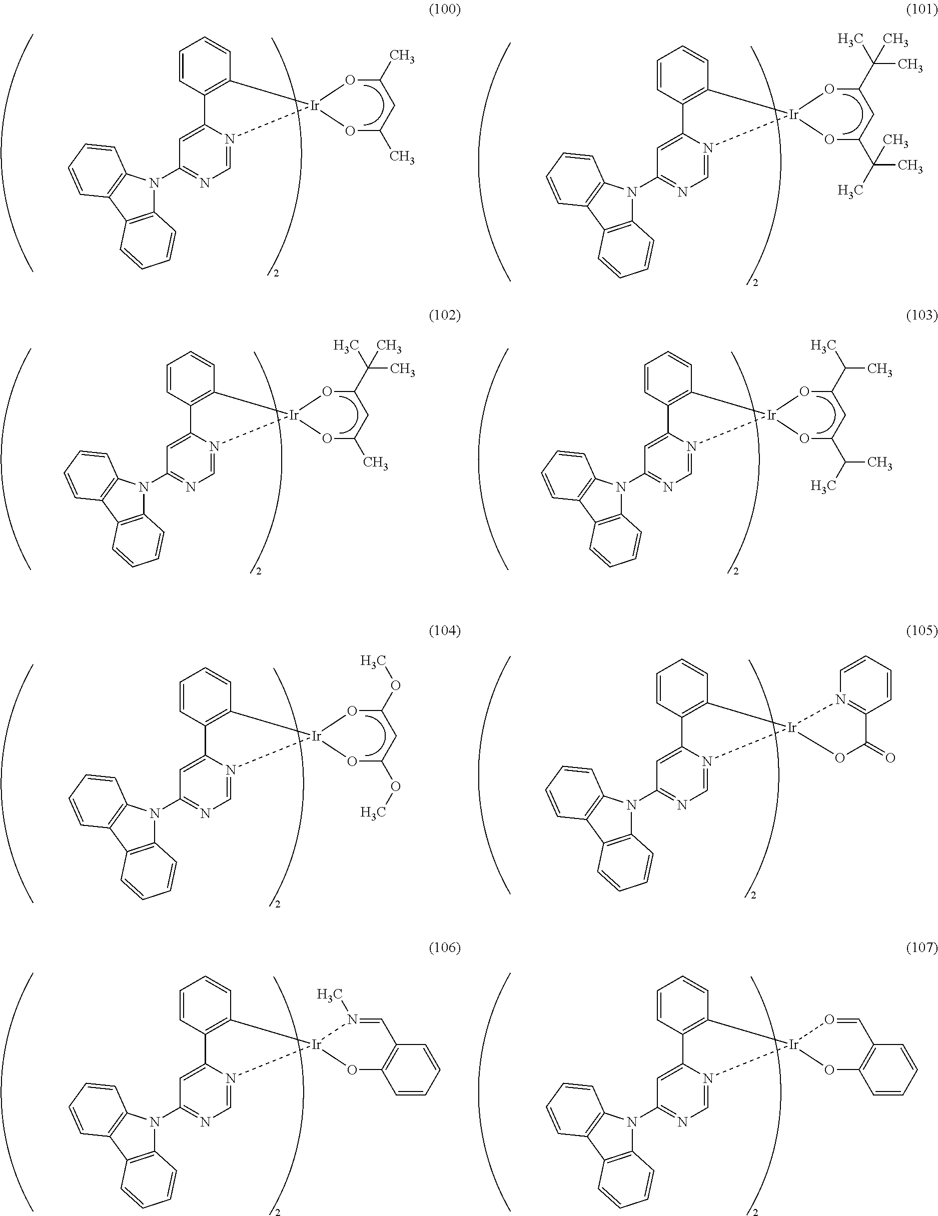

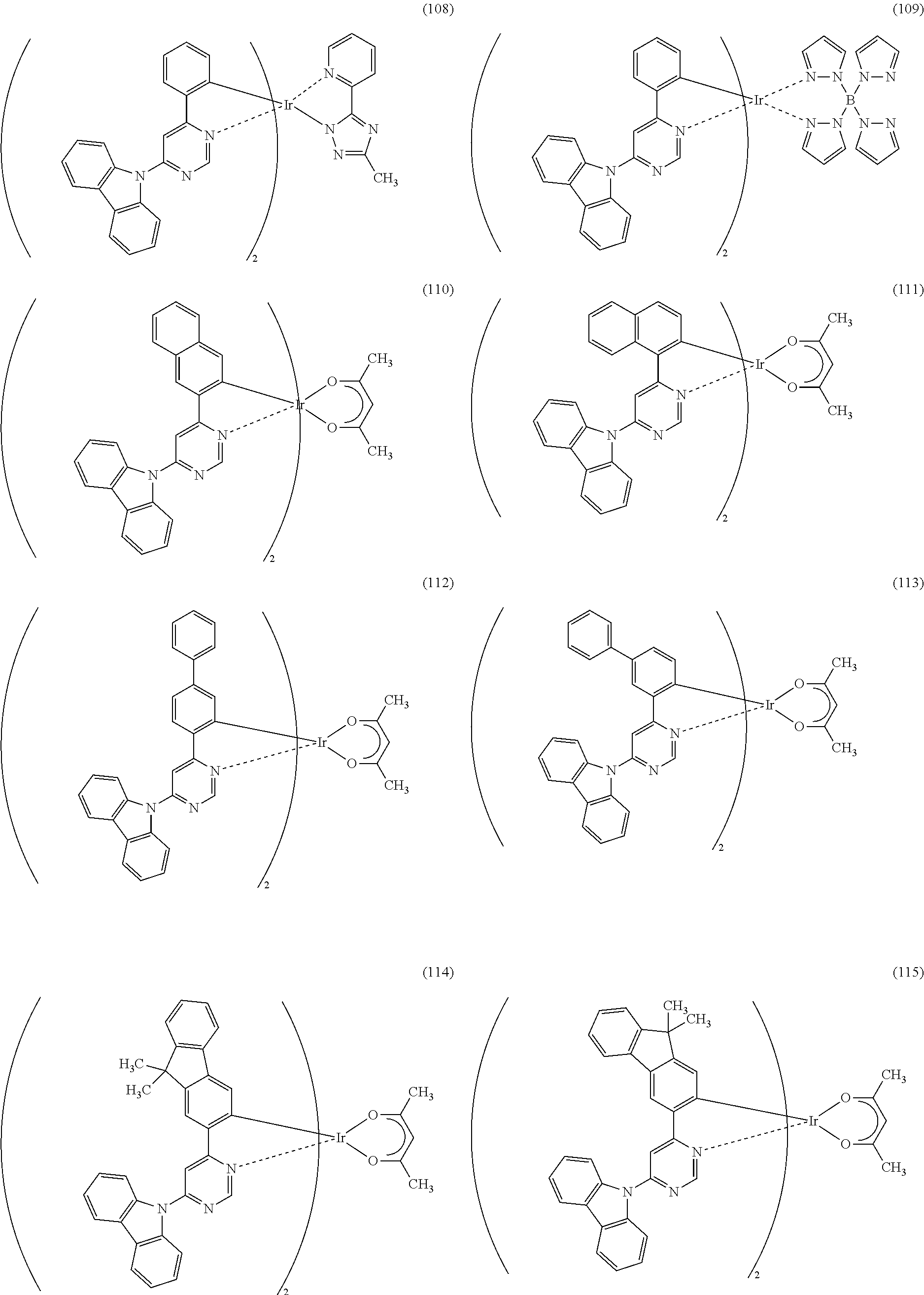

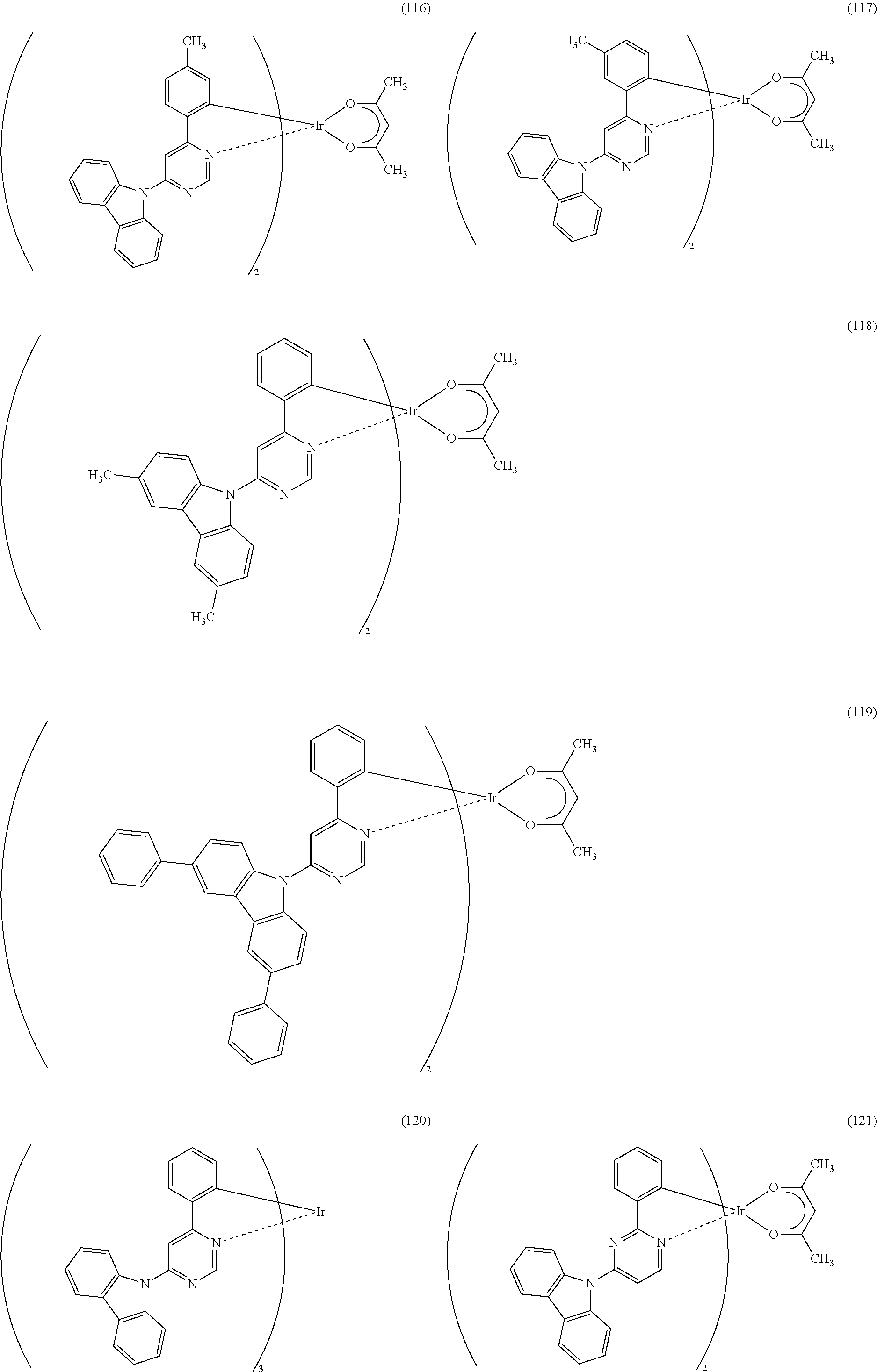

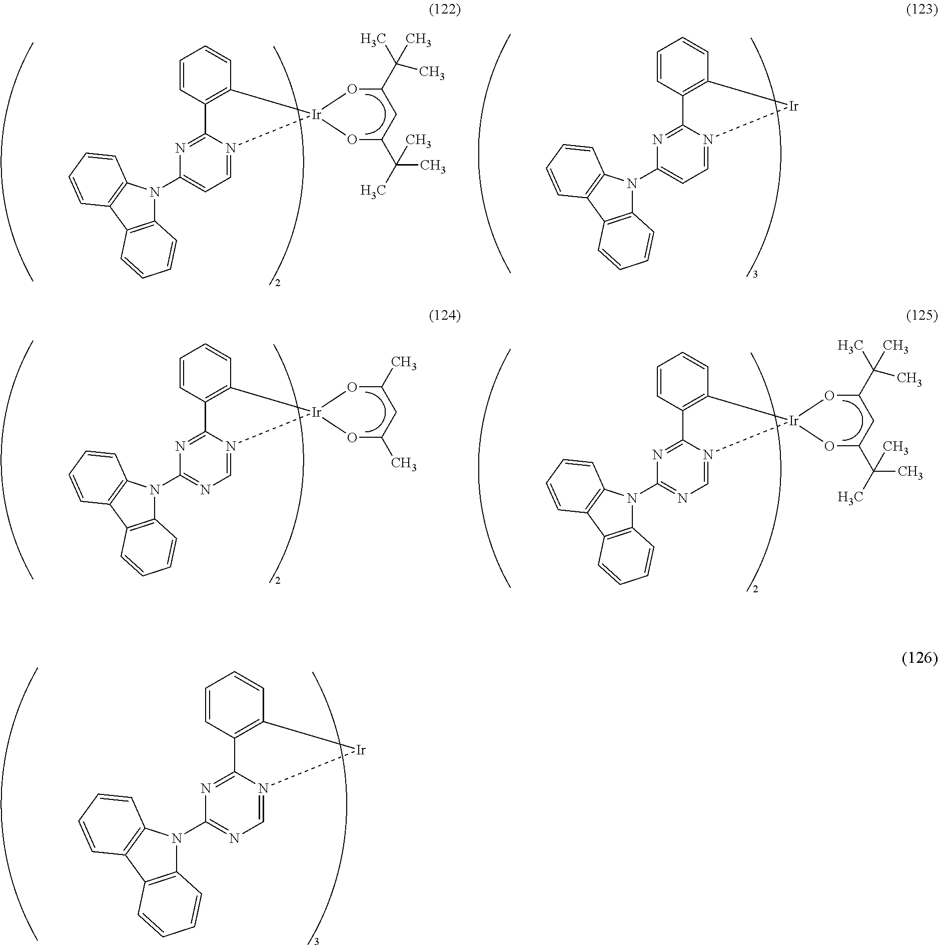

For synthesizing the phosphorescent iridium metal complex, a variety of reactions can be used. The following shows methods for synthesizing the phosphorescent iridium metal complex represented by the general formula (G1-2) or (G1-3). Note that methods for synthesizing the phosphorescent iridium metal complex represented by any of the general formulas (G2-2), (G2-3), (G3-2), and (G3-3) are modifications of the methods for synthesizing the phosphorescent iridium metal complex represented by the general formula (G1-2) or (G1-3); therefore, only methods for synthesizing a pyrimidine derivative and a triazine derivative are described and detailed description of the methods for synthesizing other phosphorescent iridium metal complexes are omitted.

### (Methods for Synthesizing a Pyrimidine Derivative Represented by a General Formula (G1-0) or (G2-0) and a Triazine Derivative Represented by a General Formula (G3-0))

First, examples of methods for synthesizing a pyrimidine derivative represented by the following general formula (G1-0) or (G2-0) and a triazine derivative represented by the following general formula (G3-0) are described. Note that the methods for synthesizing the pyridine derivative and the triazine derivative are not limited to the following methods.

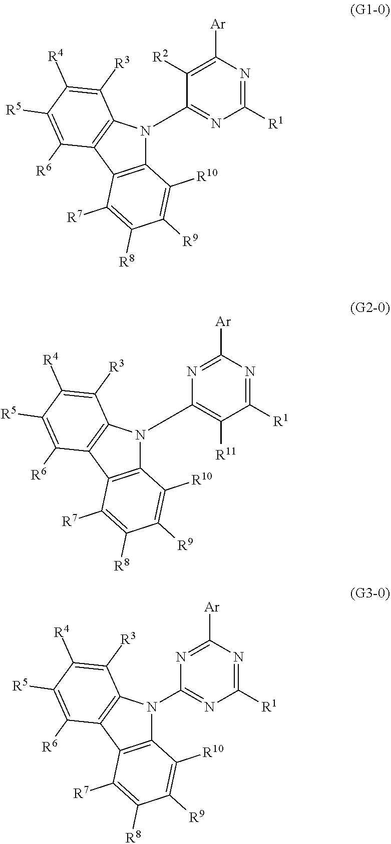

In the general formulas (G1-0), (G2-0), and (G3-0), Ar represents a substituted or unsubstituted aryl group having 6 to 13 carbon atoms. R¹, R², and separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group. The pyrimidine derivative represented by the general formula (G1-0) or (G2-0) can be synthesized by converting a chloro group into a derivative of an N-carbazolyl group with use of a chloride of a pyrimidine, and the triazine derivative represented by the general formula (G3-0) can be synthesized in a similar manner with use of a chloride of a triazine. For example, the pyrimidine derivative represented by the general formula (G1-0) can be synthesized in the following easy synthetic scheme (a). Note that the description here is about the pyrimidine derivative represented by the general formula (G1-0); however, the pyrimidine derivative represented by the general formula (G2-0) can be synthesized by replacing the chloride of the pyrimidine with another chloride of a pyrimidine, and the triazine derivative represented by the general formula (G3-0) can be synthesized by replacing the chloride of the pyrimidine with a chloride of the triazine.

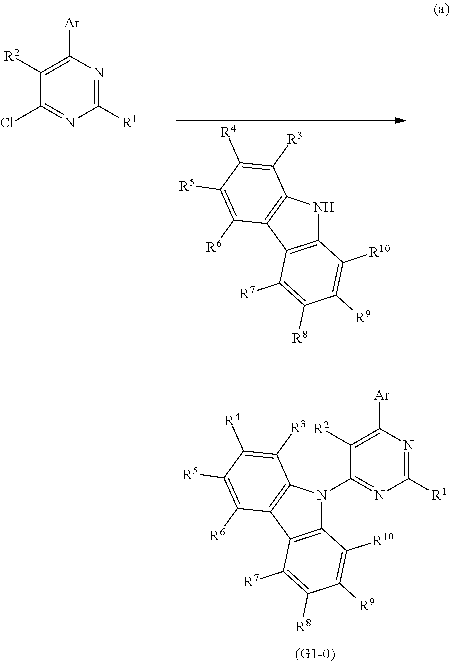

In the synthetic scheme (a), Ar represents a substituted or unsubstituted aryl group having 6 to 13 carbon atoms. R¹ and R² separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group.

The chlorides of the pyrimidine and the triazine and the carbazole derivative are commercially available or producible; accordingly, many kinds of the pyrimidine derivative and triazine derivative represented by any of the general formulas (G1-0), (G2-0), and (G3-0) can be synthesized. Therefore, one of features of the phosphorescent iridium metal complex according to one embodiment of the present invention is such wide variations of the ligand.

### (Method for Synthesizing the Phosphorescent Iridium Metal Complex Represented by the General Formula (G1-2) According to One Embodiment of the Present Invention)

Next, the phosphorescent iridium metal complex represented by the general formula (G1-2) according to one embodiment of the present invention can be synthesized in the following synthetic scheme (b). That is, the pyrimidine derivative represented by the above general formula (G1-0) and an iridium metal compound containing halogen (e.g., iridium chloride) or an organic iridium metal complex compound (e.g., an acetylacetonate complex or a diethylsulfide complex) are mixed and then heated, so that the phosphorescent iridium metal complex represented by the general formula (G1-2) is obtained.

This heating process may be performed after the pyrimidine derivative represented by the general formula (G1-0) and the iridium metal compound containing halogen or the organic iridium metal complex compound are dissolved in an alcohol-based solvent (e.g., glycerol, ethylene glycol, 2-methoxyethanol, or 2-ethoxyethanol). There is no particular limitation on a heating means, and an oil bath, a sand bath, or an aluminum block may be used. Alternatively, microwaves can be used as a heating means.

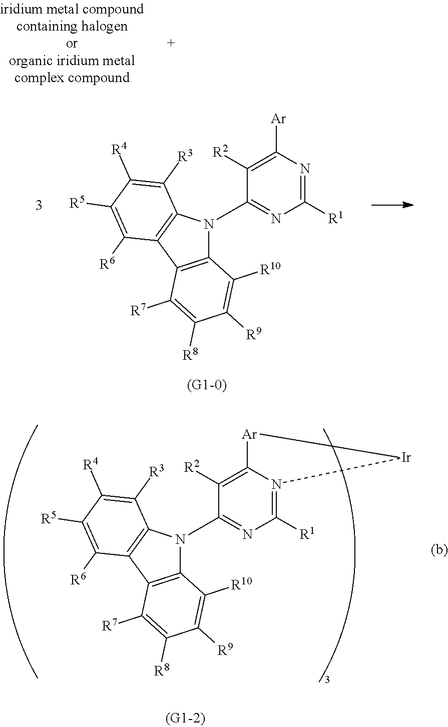

In the scheme (b), Ar represents a substituted or unsubstituted aryl group or arylene group having 6 to 13 carbon atoms. R¹ and R² separately represent hydrogen or an alkyl group having 1 to 4 carbon atoms, and R³ to R¹⁰ separately represent hydrogen, an alkyl group baying 1 to 4 carbon atoms, or a substituted or unsubstituted phenyl group.

Note that the method of synthesizing the phosphorescent iridium metal complex represented by the general formula (G1-2) according to one embodiment of the present invention is not limited to the scheme (b). For example, there is also a method shown in the following scheme (c) in which a halogen-bridged dinuclear complex (B) and the pyrimidine derivative represented by the general formula (G1-0) are heated. In this case, a silver salt such as silver trifluoroacetate or silver trifluoromethylsulfonate may be added to enhance the reaction.

### (Method for Synthesizing a Phosphorescent Iridium Metal Complex Represented by the General Formula (G1-3) According to One Embodiment of the Present Invention)

The halogen-bridged dinuclear complex (B), which is shown in a scheme (d) as a material for synthesis of the phosphorescent iridium metal complex represented by the general formula (G1-3) according to one embodiment of the present invention, can be synthesized by the following synthetic scheme (c). That is, the pyrimidine derivative represented by the general formula (G1-0) and an iridium metal compound containing halogen (e.g., iridium chloride) are heated in an inert gas atmosphere in bulk, in an alcoholic solvent (e.g., glycerol, ethylene glycol, 2-methoxyethanol, or 2-ethoxyethanol) alone, or in a mixed solvent of water and one or more of the alcoholic solvents, whereby the dinuclear complex (B), which is a novel type of an organic iridium metal complex including a halogen-bridged structure, can be obtained. There is no particular limitation on a heating means, and an oil bath, a sand bath, or an aluminum block may be used. Alternatively, microwaves can be used as a heating means.

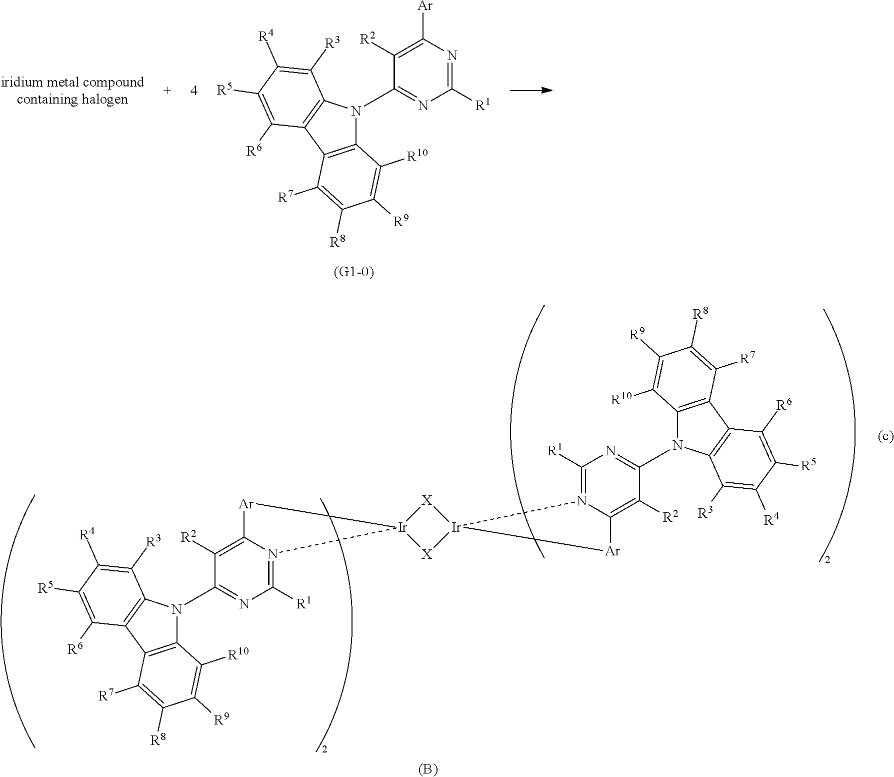

In the synthetic scheme (c), X represents a halogen, and Ar represents a substituted or unsubstituted aryle group or arylene group having 6 to 13 carbon atoms. R¹ and R² separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group.

Furthermore, as shown in the following synthetic scheme (d), the dinuclear complex (B) obtained in the above synthetic scheme (c) is reacted with HL which is a material of a monoanionic ligand in an inert gas atmosphere, whereby a proton of HL is separated and L coordinates to the central metal, iridium. Thus, the phosphorescent iridium metal complex represented by the general formula (G1-3) according to one embodiment of the present invention can be obtained. There is no particular limitation on a heating means, and an oil bath, a sand bath, or an aluminum block may be used. Alternatively, microwaves can be used as a heating means.

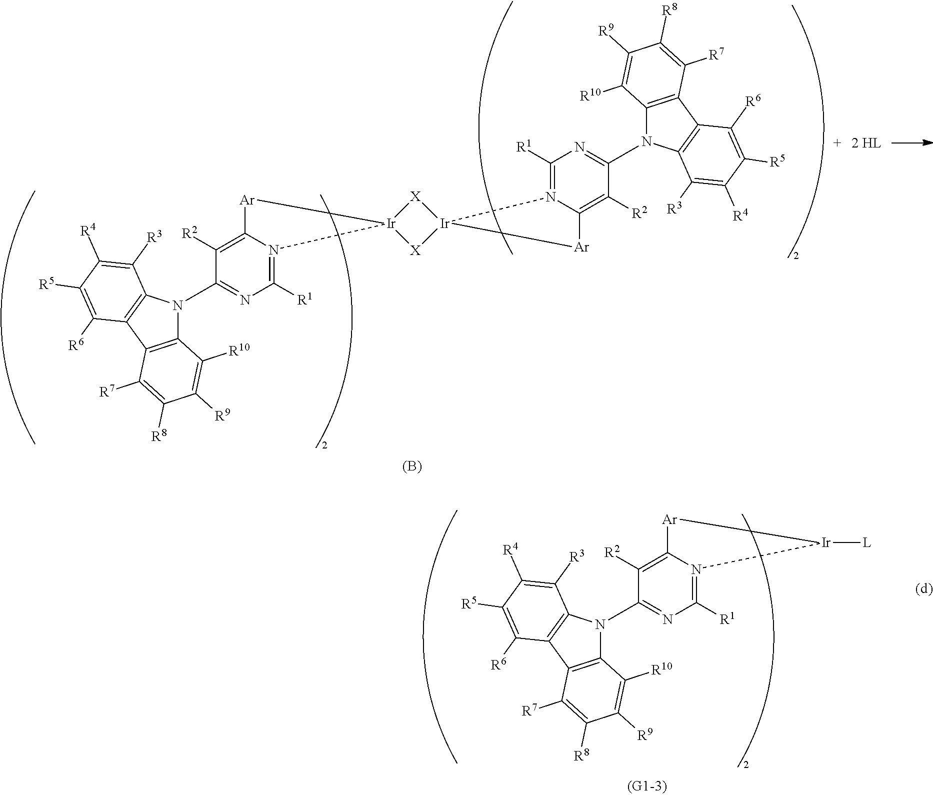

In the synthetic scheme (d), X represents a halogen, and Ar represents a substituted or unsubstituted arylene group having 6 to 13 carbon atoms. R¹ and R² separately represent hydrogen or an alkyl group having 1 to 4 carbon atoms, and R³ to R¹⁰ separately represent hydrogen, an alkyl group having 1 to 4 carbon atoms, or a substituted or unsubstituted phenyl group. Further, L represents a monoanionic ligand.

Through the above steps, the phosphorescent iridium metal complex of this embodiment can be synthesized.

Note that in the case where the light-emitting layer 113 contains the host material and the guest material, which is the above-described phosphorescent iridium metal complex, phosphorescence with high emission efficiency can be obtained from the light-emitting layer 113.

In this manner, the light-emitting layer 113 can be formed.

The following shows the electron-transport layer 114 provided over the light-emitting layer 113, and the electron-transport layer 114 contains a substance with a high electron-transport property. For the electron-transport layer 114, it is possible to use a metal complex such as Alq₃, tris(4-methyl-8-quinolinolato)aluminum (abbreviation: Almq₃), bis(10-hydroxybenzo[h]quinolinato)beryllium (abbreviation: BeBq₂), BAlq, Zn(BOX)₂, or bis[2-(2-hydroxyphenyl)benzothiazolato]zinc (abbreviation: Zn(BTZ)₂). Alternatively, it is possible to use a heteroaromatic compound such as 2-(4-biphenylyl)-5-(4-tert-butylphenyl)-1,3,4-oxadiazole (abbreviation: PBD), 1,3-bis[5-(p-tert-butylphenyl)-1,3,4-oxadiazol-2-yl]benzene (abbreviation: OXD-7), 3-(4-tert-butylphenyl)-4-phenyl-5-(4-biphenylyl)-1,2,4-triazole (abbreviation: TAZ), 3-(4-tert-butylphenyl)-4-(4-ethylphenyl)-5-(4-biphenylyl)-1,2,4-triazole (abbreviation: p-EtTAZ), bathophenanthroline (abbreviation: BPhen), bathocuproine (abbreviation: BCP), or 4,4′-bis(5-methylbenzoxazol-2-yl)stilbene (abbreviation: BzOs). Further alternatively, it is possible to use a high molecular compound such as poly(2,5-pyridinediyl) (abbreviation: PPy), poly[(9,9-dihexylfluorene-2,7-diyl)-co-(pyridine-3,5-diyl)] (abbreviation: PF-Py) or poly[(9,9-dioctylfluorene-2,7-diyl)-co-(2,2′-bipyridine-6,6′-diyl)] (abbreviation: PF-BPy). The substances mentioned here are mainly ones that have an electron mobility of 10⁻⁶ cm²/V·s or higher. Note that any substance other than the above substances may be used for the electron-transport layer as long as it is a substance in which the electron-transport property is higher than the hole-transport property.

The electron-transport layer 114 is not limited to a single layer, but may be a stack of two or more layers containing any of the above substances.

The electron-injection layer 115 is a layer containing a substance with a high electron-injection property. For the electron-injection layer 115, an alkali metal, an alkaline earth metal, or a compound thereof, such as lithium fluoride (LiF), cesium fluoride (CsF), calcium fluoride (CaF₂), or lithium oxide (LiOₓ) can be used. Alternatively, a rare earth metal compound like erbium fluoride (ErF₃) can be used. Alternatively, the above-mentioned substances for forming the electron-transport layer 114 can also be used.

Alternatively, the electron-injection layer 115 may be formed using a composite material in which an organic compound and an electron donor (donor) are mixed. The composite material is superior in an electron-injection property and an electron-transport property, since electrons are generated in the organic compound by the electron donor. In this case, the organic compound is preferably a material excellent in transporting the generated electrons. Specifically, any of the above-described substances for forming the electron-transport layer 114 (e.g., a metal complex or a heteroaromatic compound) can be used, for example. As the electron donor, a substance exhibiting an electron-donating property to the organic compound may be used. Specifically, an alkali metal, an alkaline earth metal, and a rare earth metal are preferable, and lithium, cesium, magnesium, calcium, erbium, ytterbium, and the like can be given. Further, an alkali metal oxide or an alkaline-earth metal oxide is preferable, and there are, for example, lithium oxide, calcium oxide, barium oxide, and the like. Alternatively, Lewis base such as magnesium oxide can also be used. Further alternatively, an organic compound such as tetrathiafulvalene (abbreviation: TTF) can be used.

Note that each of the above-described hole-injection layer 111, hole-transport layer 112, light-emitting layer 113, electron-transport layer 114, electron-injection layer 115, and charge-generation layer 116 can be formed by a method such as an evaporation method (e.g., a vacuum evaporation method), an inkjet method, or a coating method.

In the above-described light-emitting element, current flows due to a potential difference generated between the first electrode 101 and the second electrode 103 and holes and electrons recombine in the EL layer 102, whereby light is emitted. This emitted light is extracted out through one or both of the first electrode 101 and the second electrode 103. Therefore, one or both of the first electrode 101 and the second electrode 103 are electrodes having a light-transmitting property.

The above-described light-emitting element can emit phosphorescence originating from the phosphorescent iridium metal complex, and thus can have higher efficiency than a light-emitting element using a fluorescent compound.

Note that although the light-emitting element described in this embodiment is one structural example of a light-emitting element, a light-emitting element having another structure which is described in another embodiment can also be applied to a light-emitting device that is one embodiment of the present invention. Further, as a light-emitting device including the above light-emitting element, a passive matrix light-emitting device and an active matrix light-emitting device can be manufactured. It is also possible to manufacture a light-emitting device with a microcavity structure including a light-emitting element which is a different light-emitting element from the above light-emitting elements, as described in another embodiment. Each of the above light-emitting devices is included in the present invention.

Note that there is no particular limitation on the structure of the TFT in the case of manufacturing the active matrix light-emitting device. For example, a staggered TFT or an inverted staggered TFT can be used as appropriate. Further, a driver circuit formed over a TFT substrate may be formed using both n-channel TFTs and p-channel TFTs or only either n-channel TFTs or p-channel TFTs. Furthermore, there is no particular limitation on a semiconductor material used for the TFT. For example, it is possible to use a silicon-based semiconductor material or an oxide semiconductor material. Furthermore, there is no particular limitation on the crystallinity of a semiconductor film used for the TFT. For example, an amorphous semiconductor film, a crystalline semiconductor film, or the like can be used.

Note that the structure described in this embodiment can be used in combination with any of the structures described in the other embodiments, as appropriate.

### Embodiment 2

In this embodiment, a light-emitting element including, between a pair of electrodes, an EL layer that includes a light-emitting layer containing a phosphorescent iridium metal complex and other two or more kinds of organic compounds is described with reference to FIG. 2.

A light-emitting element described in this embodiment includes an EL layer 203 between a pair of electrodes (a first electrode 201 and a second electrode 202) as illustrated in FIG. 2. Note that the EL layer 203 includes at least a light-emitting layer 204 and may include a hole-injection layer, a hole-transport layer, an electron-transport layer, an electron-injection layer, a charge-generation layer, and the like. Note that the substances given in Embodiment 1 can be used for the hole-injection layer, the hole-transport layer, the electron-transport layer, the electron-injection layer, and the charge-generation layer. Note that the first electrode 201 is used as an anode and the second electrode 202 is used as a cathode in this embodiment.

The light-emitting layer 204 described in this embodiment contains a phosphorescent compound 205 using the phosphorescent iridium metal complex described in Embodiment 1, a first organic compound 206, and a second organic compound 207. Note that the phosphorescent compound 205 is a guest material in the light-emitting layer 204. Moreover, one of the first organic compound 206 and the second organic compound 207, the content of which is higher than that of the other h the light-emitting layer 204, is a host material in the light-emitting layer 204.

When the light-emitting layer 204 has the structure in which the guest material is dispersed in the host material, crystallization of the light-emitting layer can be suppressed. Further, it is possible to suppress concentration quenching due to high concentration of the guest material, and thus the light-emitting element can have higher emission efficiency.

Note that it is preferable that a triplet excitation energy level (T₁ level) of each of the first organic compound 206 and the second organic compound 207 be higher than that of the phosphorescent compound 205. This is because, when the T₁ level of the first organic compound 206 (or the second organic compound 207) is lower than that of the phosphorescent compound 205, the triplet excitation energy of the phosphorescent compound 205, which is to contribute to light emission, is quenched by the first organic compound 206 (or the second organic compound 207) and accordingly the emission efficiency is decreased.

Here, for improvement in efficiency of energy transfer from a host material to a guest material, Förster mechanism (dipole-dipole interaction) and Dexter mechanism (electron exchange interaction), which are known as mechanisms of energy transfer between molecules, are considered. According to the mechanisms, it is preferable that an emission spectrum of a host material (fluorescence spectrum in energy transfer from a singlet excited state, phosphorescence spectrum in energy transfer from a triplet excited state) largely overlap with an absorption spectrum of a guest material (specifically, spectrum in an absorption band on the longest wavelength (lowest energy) side). However, in general, it is difficult to obtain an overlap between a fluorescence spectrum of a host material and an absorption spectrum in an absorption band on the longest wavelength (lowest energy) side of a guest material. The reason for this is as follows: if the fluorescence spectrum of the host material overlaps with the absorption spectrum in the absorption band on the longest wavelength (lowest energy) side of the guest material, since a phosphorescence spectrum of the host material is located on a longer wavelength (lower energy) side than the fluorescence spectrum, the T₁ level of the host material becomes lower than the T₁ level of the phosphorescent compound and the above-described problem of quenching occurs; yet, when the host material is designed in such a manner that the T₁ level of the host material is higher than the T₁ level of the phosphorescent compound to avoid the problem of quenching, the fluorescence spectrum of the host material is shifted to the shorter wavelength (higher energy) side, and thus the fluorescence spectrum does not have any overlap with the absorption spectrum in the absorption band on the longest wavelength (lowest energy) side of the guest material. For that reason, in general, it is difficult to obtain an overlap between a fluorescence spectrum of a host material and an absorption spectrum in an absorption band on the longest wavelength (lowest energy) side of a guest material so as to maximize energy transfer from a singlet excited state of a host material.

Thus, in this embodiment, a combination of the first organic compound 206 and the second organic compound 207 preferably forms an excited complex (also referred to as exciplex). In this case, the first organic compound 206 and the second organic compound 207 form an exciplex at the time of recombination of carriers (electrons and holes) in the light-emitting layer 204. Thus, in the light-emitting layer 204, a fluorescence spectrum of the first organic compound 206 and that of the second organic compound 207 are converted into an emission spectrum of the exciplex which is located on a longer wavelength side. Moreover, when the first organic compound and the second organic compound are selected in such a manner that the emission spectrum of the exciplex largely overlaps with the absorption spectrum of the guest material, energy transfer from a singlet excited state can be maximized. Note that also in the case of a triplet excited state, energy transfer from the exciplex, not from the host material, is assumed to occur.

For the phosphorescent compound 205, the phosphorescent iridium metal complex described in Embodiment 1 is used. For the first organic compound 206 and the second organic compound 207, a combination of a compound which easily accepts electrons (a compound having an electron-trapping property) and a compound which easily accepts holes (a compound having a hole-trapping property) is preferably employed.

Examples of the compound which easily accepts holes include 4-phenyl-4′-(9-phenyl-9H-carbazol-3-yl)triphenylamine (abbreviation: PCBA1BP), 3-[N-(1-naphthyl)-N-(9-phenylcarbazol-3-yl)amino]-9-phenylcarbazole (abbreviation: PCzPCN1), 4,4′,4″-tris[N-(1-naphthyl)-N-phenylamino]triphenylamine (abbreviation: 1′-TNATA), 2,7-bis[N-(4-diphenylaminophenyl)-N-phenylamino]-spiro-9,9′-bifluorene (abbreviation: DPA2SF), N,N′-bis(9-phenylcarbazol-3-yl)-N,N′-diphenylbenzene-1,3-diamine (abbreviation: PCA2B), N-(9,9-dimethyl-2-N,N′-diphenylamino-9H-fluoren-7-yl)diphenylamine (abbreviation: DPNF), 4-phenyldiphenyl-(9-phenyl-9H-carbazol-3-yl)amine (abbreviation: PCA1BP), N,N′,N″-triphenyl-N,N′,N″-tris(9-phenylcarbazol-3-yl)benzene-1,3,5-triamine (abbreviation: PCA3B), 2-[N-(9-phenylcarbazol-3-yl)-N-phenylamino]spiro-9,9′-bifluorene (abbreviation: PCASF), 2-[N-(4-diphenylaminophenyl)-N-phenylamino]spiro-9,9′-bifluorene (abbreviation: DPASF), N,N-di(biphenyl-4-yl)-N-(9-phenyl-9H-carbazol-3-yl)amine (abbreviation: PCzBBA1), N,N′-bis[4-(carbazol-9-yl)phenyl]-N,N′-diphenyl-9,9-dimethylfluorene-2,7-diamine (abbreviation: YGA2F), 4,4′-bis[N-(3-methylphenyl)-N-phenylamino]biphenyl (abbreviation: TPD), 4,4′-bis[N-(4-diphenylaminophenyl)-N-phenylamino]biphenyl (abbreviation: DPAB), N-(9,9-dimethyl-9H-fluoren-2-yl)-N-{9,9-dimethyl-2-[N′-phenyl-M-(9,9-dimethyl-9H-fluoren-2-yl)amino]-9H-fluoren-7-yl}phenylamine (abbreviation: DFLADFL), 3-[N-(9-phenylcarbazol-3-yl)-N-phenylamino]-9-phenylcarbazole (abbreviation: PCzPCA1), 3-[N-(4-diphenylaminophenyl)-N-phenylamino]-9-phenylcarbazole (abbreviation: PCzDPA1), 3,6-bis[N-(4-diphenylaminophenyl)-N-phenylamino]-9-phenylcarbazole (abbreviation: PCzDFA2), 4,4′-bis(N-{4-[N′-(3-methylphenyl)-N′-phenylamino]phenyl}-N-phenylamino)biphenyl (abbreviation: DNTPD), 3,6-bis[N-(4-diphenylaminophenyl)-N-(1-naphthyl)amino]-9-phenylcarbazole (abbreviation: PCzTPN2), and 3,6-bis[N-(9-phenylcarbazol-3-yl)-N-phenylamino]-9-phenylcarbazole (abbreviation: PCzPCA2).

The above-described combination of the first organic compound 206 and the second organic compound 207 is an example of the combination which enables an exciplex to be formed. The combination is determined such that the emission spectrum of the exciplex overlaps with the absorption spectrum of the phosphorescent compound 205 and that the peak of the emission spectrum of the exciplex has a longer wavelength than the peak of the absorption spectrum of the phosphorescent compound 205.

Note that in the case where a compound which easily accepts electrons and a compound which easily accepts holes are used for the first organic compound 206 and the second organic compound 207, carrier balance can be controlled by the mixture ratio of the compounds. Specifically, the ratio of the first organic compound to the second organic compound is preferably 1:9 to 9:1.

In the light-emitting element described in this embodiment, energy transfer efficiency can be improved owing to energy transfer utilizing an overlap between an emission spectrum of an exciplex and an absorption spectrum of a phosphorescent compound; accordingly, it is possible to achieve high external quantum efficiency of a light-emitting element.

Note that in another structure of the present invention, the light-emitting layer 204 can be formed using a host molecule having a hole-trapping property and a host molecule having an electron-trapping property as the two kinds of organic compounds other than the phosphorescent compound 205 (guest material) so that a phenomenon (guest coupled with complementary hosts: GCCH) occurs in which holes and electrons are introduced to guest molecules existing in the two kinds of host molecules and the guest molecules are brought into an excited state.

At this time, the host molecule having a hole-trapping property and the host molecule having an electron-trapping property can be respectively selected from the above-described compounds which easily accept holes and the above-described compounds which easily accept electrons.

Note that the structure described in this embodiment can be used in combination with any of the structures described in the other embodiments, as appropriate.

### Embodiment 3

This embodiment shows, as one embodiment of the present invention, a light-emitting element (hereinafter referred to as tandem light-emitting element) in which a charge-generation layer is interposed between a plurality of EL layers.

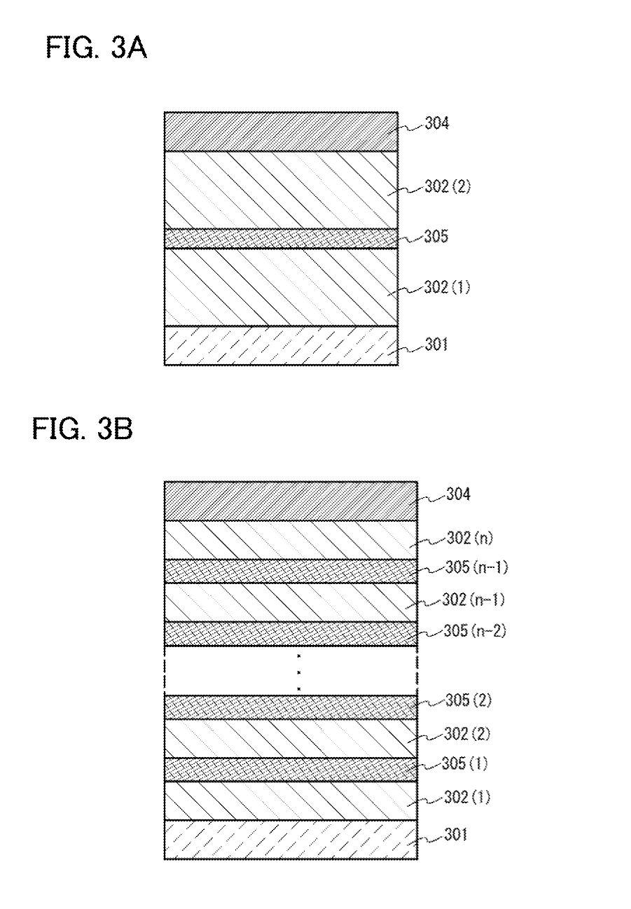

A light-emitting element described in this embodiment is a tandem light-emitting element including a plurality of EL layers (a first EL layer 302(1) and a second EL layer 302(2)) between a pair of electrodes (a first electrode 301 and a second electrode 304) as illustrated in FIG. 3A.

In this embodiment, the first electrode 301 functions as an anode, and the second electrode 304 functions as a cathode. Note that the first electrode 301 and the second electrode 304 can have structures similar to those described in Embodiment 1. In addition, although the plurality of EL layers (the first EL layer 302(1) and the second EL layer 302(2)) may have structures similar to those described in Embodiment 1 or 2, any of the EL layers may have a structure similar to that described in Embodiment 1 or 2. In other words, the structures of the first EL layer 302(1) and the second EL layer 302(2) may be the same or different from each other and can be similar to those described in Embodiment 1 or 2.

Further, a charge-generation layer 305 is provided between the plurality of EL layers (the first EL layer 302(1) and the second EL layer 302(2)). The charge-generation layer 305 has a function of injecting electrons into one of the EL layers and injecting holes into the other of the EL layers when voltage is applied between the first electrode 301 and the second electrode 304. In this embodiment, when voltage is applied such that the potential of the first electrode 301 is higher than that of the second electrode 304, the charge-generation layer 305 injects electrons into the first EL layer 302(1) and injects holes into the second EL layer 302(2).

Note that in terms of light extraction efficiency, the charge-generation layer 305 preferably has a light-transmitting property with respect to visible light (specifically, the charge-generation layer 305 has a visible light transmittance of 40% or more). Further, the charge-generation layer 305 functions even if it has lower conductivity than the first electrode 301 or the second electrode 304.

The charge-generation layer 305 may have either a structure in which an electron acceptor (acceptor) is added to an organic compound with a high hole-transport property or a structure in which an electron donor (donor) is added to an organic compound with a high electron-transport property. Alternatively, these structures may be stacked.

In the case of the structure in which an electron acceptor is added to an organic compound with a high hole-transport property, as the organic compound with a high hole-transport property, for example, an aromatic amine compound such as NPB, TPD, TDATA, MTDATA, or 4,4′-bis[N-(spiro-9,9′-bifluoren-2-yl)-N-phenylamino]biphenyl (abbreviation: BSPB) can be used. The substances mentioned here are mainly ones that have a hole mobility of 10⁻⁶ cm²/V·s or higher. Note that any substance other than the above substances may be used as long as it is an organic compound in which the hole-transport property is higher than the electron-transport property.

Further, as the electron acceptor, 7,7,8,8-tetracyano-2,3,5,6-tetrafluoroquinodimethane (abbreviation: F₄-TCNQ), chloranil, and the like can be given. In addition, a transition metal oxide can be given. In addition, an oxide of metals that belong to Group 4 to Group 8 of the periodic table can be given. Specifically, vanadium oxide, niobium oxide, tantalum oxide, chromium oxide, molybdenum oxide, tungsten oxide, manganese oxide, and rhenium oxide are preferable since their electron-accepting property is high. Among these, molybdenum oxide is especially preferable since it is stable in the air, has a low hygroscopic property, and is easily treated.

On the other hand, in the case of the structure in which an electron donor is added to an organic compound having a high electron-transport property, as the organic compound having a high electron-transport property, for example, a metal complex having a quinoline skeleton or a benzoquinoline skeleton, such as Alq, Almq₃, BeBq₂, or BAlq, can be used. Alternatively, a metal complex having an oxazole-based ligand or a thiazole-based ligand, such as Zn(BOX)₂ or Zn(BTZ)₂, can be used. Further alternatively, instead of such a metal complex, PBD, OXD-7, TAZ, BPhen, BCP, or the like can be used. The substances mentioned here are mainly ones that have an electron mobility of 10⁻⁶ cm²/V·s or higher. The second organic compound having a pyrimidine skeleton may also be used. Note that any substance other than the above substances may be used as long as it is an organic compound in which the electron-transport property is higher than the hole-transport property.

Further, as the electron donor, an alkali metal, an alkaline earth metal, a rare earth metal, a metal belonging to Group 2 or 13 of the periodic table, or an oxide or carbonate thereof can be used. Specifically, lithium (Li), cesium (Cs), magnesium (Mg), calcium (Ca), ytterbium (Yb), indium (In), lithium oxide, cesium carbonate, or the like is preferably used. Alternatively, an organic compound such as tetrathianaphthacene may be used as the electron donor.

Note that forming the charge-generation layer 305 by using the above materials can suppress an increase in driving voltage caused by the stack of the EL layers.

Although the light-emitting element having two EL layers is illustrated in FIG. 3A, the present invention can be similarly applied to a light-emitting element in which n EL layers (n is three or more) are stacked as illustrated in FIG. 3B. In the case where a plurality of EL layers (the first EL layer 302(1), the second EL layer 302(2), . . . , an (n−1)-th EL layer 302(n−1) and an n-th EL layer 302(n)) are arranged between a pair of electrodes, like the light-emitting element according to this embodiment, by arranging a charge-generation layer (a first charge-generation layer 305(1), a second charge-generation layer 305(2), . . . , an (n−2)-th charge-generation layer 305(n−2) and an (n−1)-th charge-generation layer 305(n−1)) between an EL layer and another EL layer, an element can emit light in a high luminance region with current density kept low. Since the current density can be kept low, the element can have a long lifetime. When the light-emitting element is applied for illumination, voltage drop due to resistance of an electrode material can be reduced, thereby achieving homogeneous light emission in a large area. Moreover, a light-emitting device of low power consumption, which can be driven at a low voltage, can be achieved.

Further, by forming EL layers to emit light of different colors from each other, a light-emitting element as a whole can provide light emission of a desired color. For example, by forming a light-emitting element having two EL layers such that the emission color of the first EL layer and the emission color of the second EL layer are complementary colors, the light-emitting element can provide white light emission as a whole. Note that the word “complementary” means color relationship in which an achromatic color is obtained when colors are mixed. In other words, when lights obtained from substances which emit light of complementary colors are mixed, white emission can be obtained.

Further, the same can be applied to a light-emitting element having three EL layers. For example, the light-emitting element as a whole can provide white light emission when the emission color of a first EL layer is red, the emission color of a second EL layer is green, and the emission color of a third EL layer is blue.

Note that the structure described in this embodiment can be used in combination with any of the structures described in the other embodiments, as appropriate.

### Embodiment 4

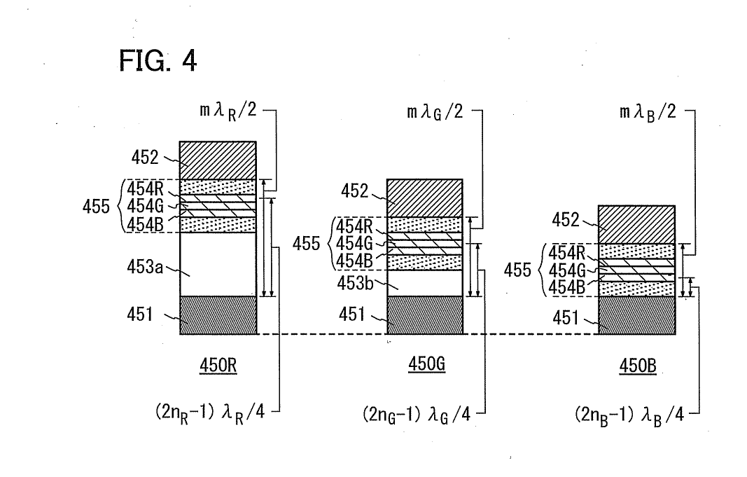

In this embodiment, a light-emitting device including a light-emitting element including an EL layer that contains a phosphorescent iridium metal complex is described with reference to FIG. 4.

A light-emitting device described in this embodiment has a micro optical resonator (microcavity) structure in which a light resonant effect between a pair of electrodes is utilized. The light-emitting device includes a plurality of light-emitting elements each of which has at least an EL layer 455 between a pair of electrodes (a reflective electrode 451 and a semi-transmissive and semi-reflective electrode 452) as illustrated in FIG. 4. Further, the EL layer 455 includes at least a first light-emitting layer 454B, a second light-emitting layer 454G, and a third light-emitting layer 454R, each of which serves as a light-emitting region. The EL layer 455 may further include a hole-injection layer, a hole-transport layer, an electron-transport layer, an electron-injection layer, a charge-generation layer, and the like. Note that a phosphorescent iridium metal complex according to one embodiment of the present invention is contained in at least one of the first light-emitting layer 454B, the second light-emitting layer 454G, and the third light-emitting layer 454R.

This embodiment shows a light-emitting device which includes light-emitting elements (a first light-emitting element 450R, a second light-emitting element 450G, and a third light-emitting element 450B) having different structures as illustrated in FIG. 4.

The first light-emitting element 450R has a structure in which a first transparent conductive layer 453a, the EL layer 455, the semi-transmissive and semi-reflective electrode 452 are sequentially stacked over the reflective electrode 451. The second light-emitting element 4500 has a structure in which a second transparent conductive layer 453b, the EL layer 455, and the semi-transmissive and semi-reflective electrode 452 are sequentially stacked over the reflective electrode 451. The third light-emitting element 450B has a structure in which the EL layer 455 and the semi-transmissive and semi-reflective electrode 452 are sequentially stacked over the reflective electrode 451.

Note that the reflective electrode 451, the EL layer 455, and the semi-transmissive and semi-reflective electrode 452 are common to the light-emitting elements (the first light-emitting element 450R, the second light-emitting element 450G, and the third light-emitting element 450B).

The EL layer 455 includes the first light-emitting layer 454B, the second light-emitting layer 454G, and the third light-emitting layer 454R. The first light-emitting layer 454B, the second light-emitting layer 454G, and the third light-emitting layer 454R emit a light (λ_{B}) having a peak in a wavelength range from 420 nm to 480 nm, a light (λ_{G}) having a peak in a wavelength range from 500 nm to 550 nm, and a light (λ_{R}) having a peak in a wavelength range from 600 nm to 760 nm, respectively. Thus, in each of the light-emitting elements (the first light-emitting element 450R, the second light-emitting element 450G and the third light-emitting element 450B), the lights emitted from the first light-emitting layer 454B, the second light-emitting layer 454G and the third light-emitting layer 454R overlap with each other; accordingly, light having a broad emission spectrum that covers a visible light range can be emitted. Note that the above wavelengths satisfy the relation of λ_{B}<λ_{G}<<λ_{R}.

Each of the light-emitting elements described in this embodiment has a structure in which the EL layer 455 is interposed between the reflective electrode 451 and the semi-transmissive and semi-reflective electrode 452. The lights emitted in all directions from the light-emitting layers included in the EL layer 455 are resonated by the reflective electrode 451 and the semi-transmissive and semi-reflective electrode 452 which function as a micro optical resonator (microcavity). Note that the reflective electrode 451 is formed using a conductive material having reflectivity, and a film whose visible light reflectivity is 40% to 100%, preferably 70% to 100%, and whose resistivity is 1×10⁻² Ω·cm or lower is used. In addition, the semi-transmissive and semi-reflective electrode 452 is formed using a conductive material having reflectivity and a conductive material having a light-transmitting property, and a film whose visible light reflectivity is 20% to 80%, preferably 40% to 70%, and whose resistivity is 1×10⁻² Ω·cm or lower is used.

In this embodiment, the thicknesses of the transparent conductive layers (the first transparent conductive layer 453a and the second transparent conductive layer 453b) provided in the first light-emitting element 450R and the second light-emitting element 450G respectively, are varied between the light-emitting elements, whereby the light-emitting elements differ in the optical path length from the reflective electrode 451 to the semi-transmissive and semi-reflective electrode 452. In other words, in light having a broad emission spectrum, which is emitted from the light-emitting layers of each of the light-emitting elements, light with a wavelength that is resonated between the reflective electrode 451 and the semi-transmissive and semi-reflective electrode 452 can be enhanced while light with a wavelength that is not resonated therebetween can be attenuated. Thus, when the elements differ in the optical path length from the reflective electrode 451 to the semi-transmissive and semi-reflective electrode 452, light with different wavelengths can be extracted.

Note that the optical path length (also referred to as optical distance) is expressed as a product of an actual distance and a refractive index, and in this embodiment, is a product of an actual thickness and n (refractive index). That is, the following relation is satisfied: an optical path length=actual thickness×n (refractive index).

Further, the optical path length from the reflective electrode 451 to the semi-transmissive and semi-reflective electrode 452 is set to mλ_{R}/2 (in is a natural number of 1 or more) in the first light-emitting element 450R; the optical path length from the reflective electrode 451 to the semi-transmissive and semi-reflective electrode 452 is set to mλ_{G}/2 (in is a natural number of 1 or more) in the second light-emitting element 450G; and the optical path length from the reflective electrode 451 to the semi-transmissive and semi-reflective electrode 452 is set to mλ_{B}/2 (m is a natural number of 1 or more) in the third light-emitting element 450B.

In this manner, the light (λ_{R}) emitted from the third light-emitting layer 454R included in the EL layer 455 is mainly extracted from the first light-emitting element 450R, the light (λ_{G}) emitted from the second light-emitting layer 454G included in the EL layer 455 is mainly extracted from the second light-emitting element 450G, and the light (λ_{B}) emitted from the first light-emitting layer 454B included in the EL layer 455 is mainly extracted from the third light-emitting element 450B. Note that the light extracted from each of the light-emitting elements is emitted through the semi-transmissive and semi-reflective electrode 452 side.

Further, strictly speaking, the optical path length from the reflective electrode 451 to the semi-transmissive and semi-reflective electrode 452 is the distance from a reflection region in the reflective electrode 451 to a reflection region in the semi-transmissive and semi-reflective electrode 452. However, it is difficult to precisely determine the positions of the reflection regions in the reflective electrode 451 and the semi-transmissive and semi-reflective electrode 452; therefore, the above effect can be sufficiently obtained wherever the reflection regions may be set in the reflective electrode 451 and the semi-transmissive and semi-reflective electrode 452.

Next, the optical path length from the reflective electrode 451 to the third light-emitting layer 454R is adjusted to (2n_{R}−1)λR/4 (n_{R} is a natural number of 1 or more) because in the first light-emitting element 450R, light (first reflected light) that is reflected by the reflective electrode 451 of the light emitted from the third light-emitting layer 454R interferes with light (first incident light) that directly enters the semi transmissive and semi-reflective electrode 452 from the third light-emitting layer 454R. By adjusting the optical path length, the phases of the first reflected light and the first incident light can be aligned with each other and the light emitted from the third light-emitting layer 454R can be amplified.

Note that, strictly speaking, the optical path length from the reflective electrode 451 to the third light-emitting layer 454R is the optical path length from a reflection region in the reflective electrode 451 to a light-emitting region in the third light-emitting layer 454R. However, it is difficult to precisely determine the positions of the reflection region in the reflective electrode 451 and the light-emitting region in the third light-emitting layer 454R; therefore, the above effect can be sufficiently obtained wherever the reflection region and the light-emitting region may be set in the reflective electrode 451 and the third light-emitting layer 454R, respectively.

Next, the optical path length from the reflective electrode 451 to the second light-emitting layer 454G is adjusted to (2n_{G}−1)λ_{G}/4 (n_{G} is a natural number of 1 or more) because in the second light-emitting element 450G, light (second reflected light) that is reflected by the reflective electrode 451 of the light emitted from the second light-emitting layer 454G interferes with light (second incident light) that directly enters the semi-transmissive and semi-reflective electrode 452 from the second light-emitting layer 454G. By adjusting the optical path length, the phases of the second reflected light and the second incident light can be aligned with each other and the light emitted from the second light-emitting layer 454G can be amplified.

Note that, strictly speaking, the optical path length from the reflective electrode 451 to the second light-emitting layer 454G is the optical path length from a reflection region in the reflective electrode 451 to a light-emitting region in the second light-emitting layer 454G. However, it is difficult to precisely determine the positions of the reflection region in the reflective electrode 451 and the light-emitting region in the second light-emitting layer 454G; therefore, the above effect can be sufficiently obtained wherever the reflection region and the light-emitting region may be set in the reflective electrode 451 and the second light-emitting layer 454G, respectively.

Next, the optical path length front the reflective electrode 451 to the first light-emitting layer 454B is adjusted to (2n_{B}−1)λ_{B}/4 (n_{B} is a natural number of 1 or more) because in the third light-emitting element 450B, light (third reflected light) that is reflected by the reflective electrode 451 of the light emitted from the first light-emitting layer 454B interferes with light (third incident light) that directly enters the semi-transmissive and semi-reflective electrode 452 from the first light-emitting layer 454B. By adjusting the optical path length, the phases of the third reflected light and the third incident light can be aligned with each other and the light emitted from the first light-emitting layer 454B can be amplified.

Note that, strictly speaking, the optical path length from the reflective electrode 451 to the first light-emitting layer 454B is the optical path length from a reflection region in the reflective electrode 451 to a light-emitting region in the first light-emitting layer 454B. However, it is difficult to precisely determine the positions of the reflection region in the reflective electrode 451 and the light-emitting region in the first light-emitting layer 454B; therefore, the above effect can be sufficiently obtained wherever the reflection region and the light-emitting region may be set in the reflective electrode 451 and the first light-emitting layer 454B, respectively.

Note that although each of the light-emitting elements in the above-described structure includes a plurality of light-emitting layers in the EL layer, the present invention is not limited thereto; for example, the structure of the tandem (stacked type) light-emitting element which is described in Embodiment 3 can be combined, in which case a plurality of EL layers is provided so that a charge-generation layer is interposed therebetween in one light-emitting element and one or more light-emitting layers are formed in each of the EL layers.

The light-emitting device described in this embodiment has a microcavity structure, in which light with wavelengths which differ depending on the light-emitting elements can be extracted even when they include the same EL layers, so that it is not needed to form different light-emitting layers for the colors of R, G, and B. Therefore, the above structure is advantageous for full color display owing to easiness in achieving higher resolution display or the like. In addition, emission intensity with a predetermined wavelength in the front direction can be increased, whereby power consumption can be reduced. The above structure is particularly useful in the case of being applied to a color display (image display device) including pixels of three or more colors but may also be applied to lighting or the like.

Note that the structure described in this embodiment can be used in combination with any of the structures described in the other embodiments, as appropriate.

### Embodiment 5

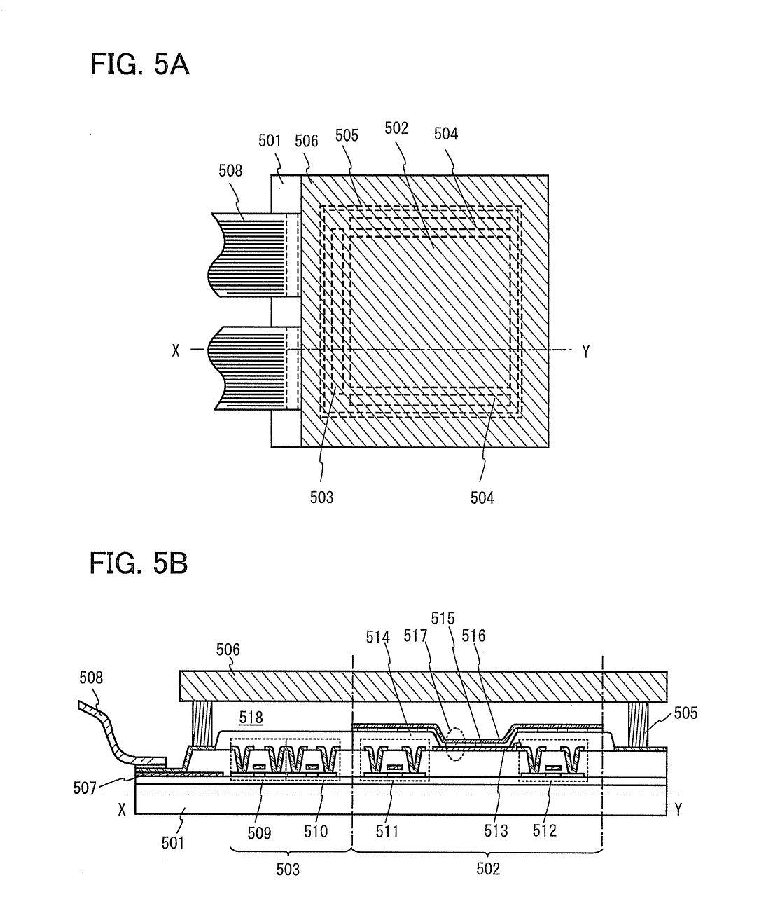

In this embodiment, a light-emitting device including a light-emitting element according to one embodiment of the present invention is described with reference to FIGS. 5A and 5B.

The light-emitting device including the light-emitting element according to one embodiment of the present invention can be either a passive matrix light-emitting device or an active matrix light-emitting device. Note that any of the light-emitting elements described in the other embodiments can be applied to the light-emitting device described in this embodiment.

In this embodiment, as a light-emitting device including the light-emitting element according to one embodiment of the present invention, an active matrix light-emitting device is described with reference to FIGS. 5A and 5B.

FIG. 5A illustrates a top view of the light-emitting device and FIG. 5B illustrates a cross-sectional view taken along dashed-dotted line X-Y in FIG. 5A. The active matrix light-emitting device according to this embodiment includes a pixel portion 502 provided over an element substrate 501, a driver circuit portion (a source line driver circuit) 503, and a driver circuit portion (a gate line driver circuit) 504. The pixel portion 502, the driver circuit portion 503, and the driver circuit portion 504 are sealed with a sealant 505 between the element substrate 501 and a sealing substrate 506.

In addition, over the element substrate 501, a lead wiring 507 for connecting an external input terminal, through which a signal (e.g., a video signal, a clock signal, a start signal, a reset signal, or the like) or electric potential from the outside is transmitted to the driver circuit portion 503 and the driver circuit portion 504, is provided. Here, an example is described in which an FPC 508 is provided as the external input terminal. Although only the FPC is illustrated here, a printed wiring board (PWB) may be attached to the FPC. The light-emitting device in this specification includes not only a light-emitting device itself but also a light-emitting device with an FPC or a PWB attached.

Next, a cross-sectional structure is described with reference to FIG. 5B. The driver circuit portion and the pixel portion are formed over the element substrate 501; here are illustrated the driver circuit portion 503 which is the source line driver circuit and the pixel portion 502.

The driver circuit portion 503 is an example where a CMOS circuit is formed, which is a combination of an n-channel TFT 509 and a p-channel TFT 510. Note that a circuit included in the driver circuit portion may be formed using various CMOS circuits, PMOS circuits, or NMOS circuits. In this embodiment, although a driver-integrated type structure in which a driver circuit is formed over a substrate is described, a driver circuit is not necessarily formed over a substrate but can be formed outside a substrate.

The pixel portion 502 is formed of a plurality of pixels each of which includes a switching TFT 511, a current control TFT 512, and a first electrode 513 which is electrically connected to a wiring (a source electrode or a drain electrode) of the current control TFT 512. An insulator 514 is formed so as to cover edge portions of the first electrode 513. Here, the insulator 514 is formed using a positive photosensitive acrylic resin. Note that the first electrode 513 is used as an anode and a second electrode 516 is used as a cathode in this embodiment.

In addition, in order to obtain favorable coverage with a film which is to be stacked over the insulator 514, the insulator 514 is preferably formed so as to have a curved surface with curvature at an upper edge portion or a lower edge portion. For example, in the case of using a positive photosensitive acrylic resin as a material for the insulator 514, the insulator 514 is preferably formed so as to have a curved surface with a curvature radius (0.2 μm to 3 μm) at the upper edge portion. Note that the insulator 514 can be formed using either a negative photosensitive resin or a positive photosensitive resin. It is possible to use, without limitation to an organic compound, either an organic compound or an inorganic compound such as silicon oxide or silicon oxynitride.

An EL layer 515 and the second electrode 516 are stacked over the first electrode 513. In the EL layer 515, at least a light-emitting layer is provided which contains a phosphorescent iridium metal complex according to one embodiment of the present invention. Further, in the EL layer 515, a hole-injection layer, a hole-transport layer, an electron-transport layer, an electron-injection layer, a charge-generation layer, and the like can be provided as appropriate in addition to the light-emitting layer.

A light-emitting element 517 is formed of a stacked structure of the first electrode 513, the EL layer 515, and the second electrode 516. For the first electrode 513, the EL layer 515, and the second electrode 516, the materials described in Embodiment 1 can be used. Although not illustrated, the second electrode 516 is electrically connected to an FPC 508 which is an external input terminal.

In addition, although the cross-sectional view of FIG. 5B illustrates only one light-emitting element 517, a plurality of light-emitting elements are arranged in matrix in the pixel portion 502. Light-emitting elements that emit light of three kinds of colors (R, G, and B) are selectively formed in the pixel portion 502, whereby a light-emitting device capable of full color display can be obtained. Alternatively, a light-emitting device which is capable of full color display may be obtained by a combination with color filters.

Further, the sealing substrate 506 is attached to the element substrate 501 with the sealant 505, whereby the light-emitting element 517 is provided in a space 518 surrounded by the element substrate 501, the sealing substrate 506, and the sealant 505. Note that the space 518 may be filled with an inert gas (such as nitrogen and argon) or the sealant 505.

An epoxy-based resin is preferably used for the sealant 505. A material used for these is desirably a material which does not transmit moisture or oxygen as much as possible. As the sealing substrate 506, a plastic substrate formed of fiberglass-reinforced plastics (FRP), polyvinyl fluoride (PVF), polyester, acrylic resin, or the like can be used besides a glass substrate or a quartz substrate.

As described above, an active matrix light-emitting device can be obtained.

Note that the structure described in this embodiment can be used in combination with any of the structures described in the other embodiments, as appropriate.

### Embodiment 6

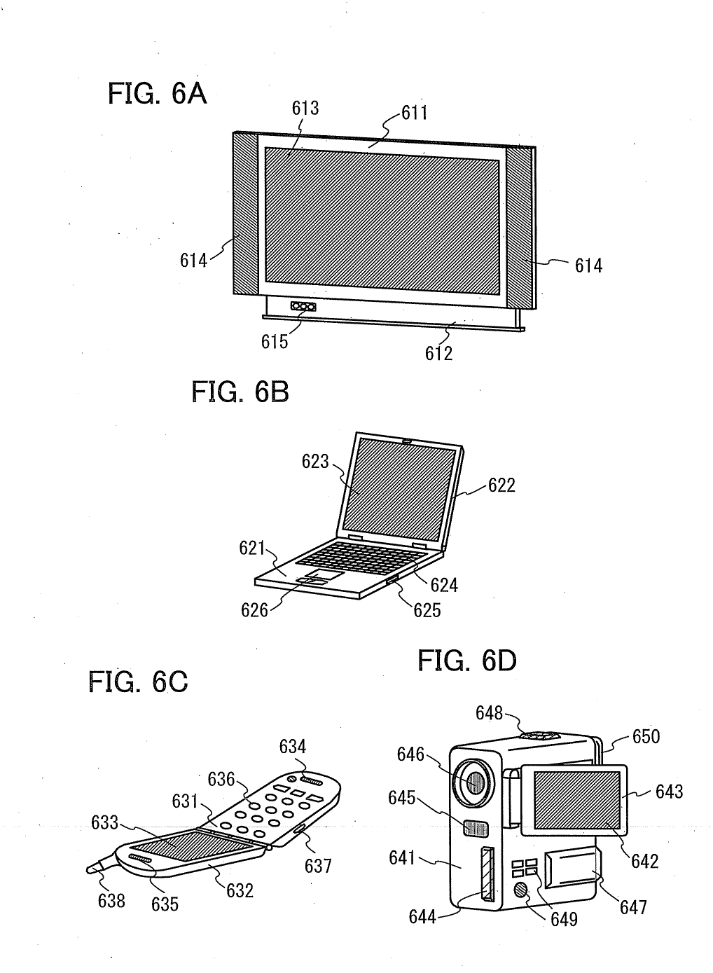

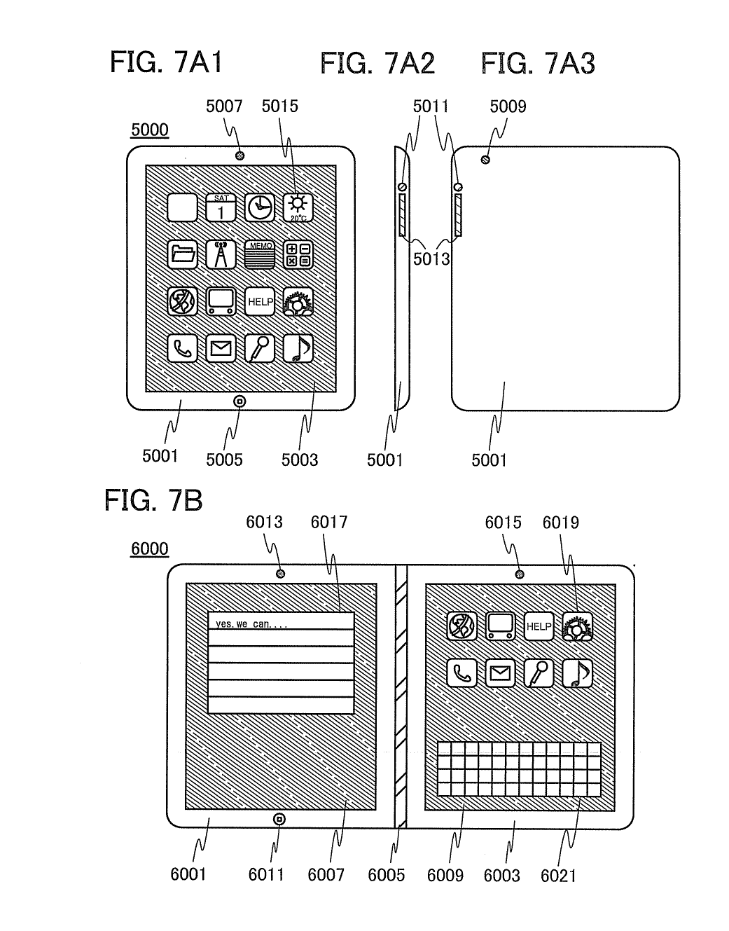

This embodiment shows electronic appliances each of which includes the light-emitting device according to one embodiment of the present invention described in the above embodiment. Examples of the electronic appliances include cameras such as digital video cameras and digital cameras, goggle type displays, navigation systems, audio reproducing devices (e.g., car audio systems and audio systems), computers, game machines, portable information terminals (e.g., mobile computers, tablet terminals, mobile phones, portable game machines, and electronic book readers), image reproducing devices in which a recording medium is provided (specifically, devices that are capable of reproducing recording media such as digital versatile discs (DVDs) and provided with a display device that can display an image), and the like. Specific examples of those electronic appliances are shown in FIGS. 6A to 6D and FIGS. 7A1, 7A2, 7A3, and 7B.

FIG. 6A illustrates a television set according to one embodiment of the present invention, which includes a housing 611, a supporting base 612, a display portion 613, speaker portions 614, video input terminals 615, and the like. In this television set, the light-emitting device according to one embodiment of the present invention can be applied to the display portion 613. Since the light-emitting device according to one embodiment of the present invention is driven at a low voltage and has high current efficiency, by the application of the light-emitting device according to one embodiment of the present invention, a television set with reduced power consumption can be obtained.

FIG. 6B illustrates a computer according to one embodiment of the present invention, which includes a main body 621, a housing 622, a display portion 623, a keyboard 624, an external connection port 625, a pointing device 626, and the like. In this computer, the light-emitting device according to one embodiment of the present invention can be applied to the display portion 623. Since the light-emitting device according to one embodiment of the present invention is driven at a low voltage and has high current efficiency, by the application of the light-emitting device according to one embodiment of the present invention, a computer with reduced power consumption can be obtained.

FIG. 6C illustrates a mobile phone according to one embodiment of the present invention, which includes a main body 631, a housing 632, a display portion 633, an audio input portion 634, an audio output portion 635, operation keys 636, an external connection port 637, an antenna 638, and the like. In this mobile phone, the light-emitting device according to one embodiment of the present invention can be applied to the display portion 633. Since the light-emitting device according to one embodiment of the present invention is driven at a low voltage and has high current efficiency, by the application of the light-emitting device according to one embodiment of the present invention, a mobile phone with reduced power consumption can be obtained.

FIG. 6D illustrates a digital video camera according to one embodiment of the present invention, which includes a main body 641, a display portion 642, a housing 643, an external connection port 644, a remote control receiving portion 645, an image receiving portion 646, a battery 647, an audio input portion 648, operation keys 649, an eyepiece portion 650, and the like. In this digital video camera, the light-emitting device according to one embodiment of the present invention can be applied to the display portion 642. Since the light-emitting device according to one embodiment of the present invention is driven at a low voltage and has high current efficiency, by the application of the light-emitting device according to one embodiment of the present invention, a camera with reduced power consumption can be obtained.

FIGS. 7A1, 7A2, 7A3, and 7B illustrate examples of a tablet terminal. FIGS. 7A1, 7A2, and 7A3 illustrate a tablet terminal 5000. FIG. 7B illustrates a tablet terminal 6000.

FIGS. 7A1, 7A2, and 7A3 are a front view, a side view, and a rear view of the tablet terminal 5000, respectively. FIG. 78 is a front view of the tablet terminal 6000.

The tablet terminal 5000 includes a housing 5001, a display portion 5003, a power button 5005, a front camera 5007, a rear camera 5009, a first external connection terminal 5011, a second external connection terminal 5013, and the like.

In addition, the display portion 5003 is incorporated in the housing 5001 and can be used as a touch panel. For example, e-mailing or schedule management can be performed by touching an icon 5015 and the like on the display portion 5003. Further, the front camera 5007 is incorporated on the front side of the housing 5001, whereby an image on the user's side can be taken. The rear camera 5009 is incorporated in the rear side of the housing 5001, whereby an image on the opposite side of the user can be taken. Further, the housing 5001 includes the first external connection terminal 5011 and the second external connection terminal 5013. Sound can be output to an earphone or the like through the first external connection terminal 5011, and data can be moved through the second external connection terminal 5013, for example.

The tablet terminal 6000 in FIG. 7B includes a first housing 6001, a second housing 6003, a hinge portion 6005, a first display portion 6007, a second display portion 6009, a power button 6011, a first camera 6013, a second camera 6015, and the like.

The first display portion 6007 is incorporated in the first housing 6001. The second display portion 6009 is incorporated in the second housing 6003. For example, the first display portion 6007 and the second display portion 6009 are used as a display panel and a touch panel, respectively. By looking at a text icon 6017 displayed on the first display portion 6007 and by touching the icon 6019 or a keyboard 6021 (actually a keyboard image displayed on the second display portion 6009), image selecting, text input, and the like can be made. Needless to say, alternatively, the first display portion 6007 and the second display portion 6009 may be a touch panel and a display panel, respectively, or the first display portion 6007 and the second display portion 6009 may be touch panels.

The first housing 6001 and the second housing 6003 are connected to each other and open and close on the hinge portion 6005. With this structure, when the first display portion 6007 incorporated in the first housing 6001 and the second display portion 6009 incorporated in the second housing 6003 are faced each other in carrying the tablet terminal 6000, the surfaces of the first display portion 6007 and the second display portion 6009 (e.g., plastic substrates) can be protected, which is preferable.

Alternatively, the first housing 6001 and the second housing 6003 may be separated by the hinge portion 6005 (so-called convertible type). Thus, the application range of the tablet terminal 6000 can be extended, and for example, the first housing 6001 is used in a vertical orientation and the second housing 6003 is used in a horizontal orientation.

Further, the first camera 6013 and the second camera 6015 can take 3D images.

The tablet terminal 5000 and the tablet terminal 6000 may send and receive data wirelessly. For example, through wireless internet connection, desired data can be purchased and downloaded.

The tablet terminals 5000 and 6000 can have other functions such as a function of displaying various kinds of data (e.g., a still image, a moving image, and a text image), a function of displaying a calendar, a date, the time, or the like on the display portion, a touch-input function of operating or editing the data displayed on the display portion by touch input, and a function of controlling processing by various kinds of software (programs). A detector such as a photodetector capable of optimizing display luminance in accordance with the amount of outside light or a sensor for detecting inclination, like a gyroscope sensor or an acceleration sensor, can be included.

The light-emitting device according to one embodiment of the present invention can be applied to the display portion 5003 of the tablet terminal 5000, the first display portion 6007 of the tablet terminal 6000, and/or the second display portion 6009 of the tablet terminal 6000. Since the light-emitting device according to one embodiment of the present invention is driven at a low voltage and has high emission efficiency, a tablet terminal with reduced power consumption can be obtained.

As thus described, the application range of the light-emitting device according to one embodiment of the present invention is quite wide, and this light-emitting device can be applied to electronic appliances of a variety of fields. With use of the light-emitting device according to one embodiment of the present invention, an electronic appliance with reduced power consumption can be obtained.

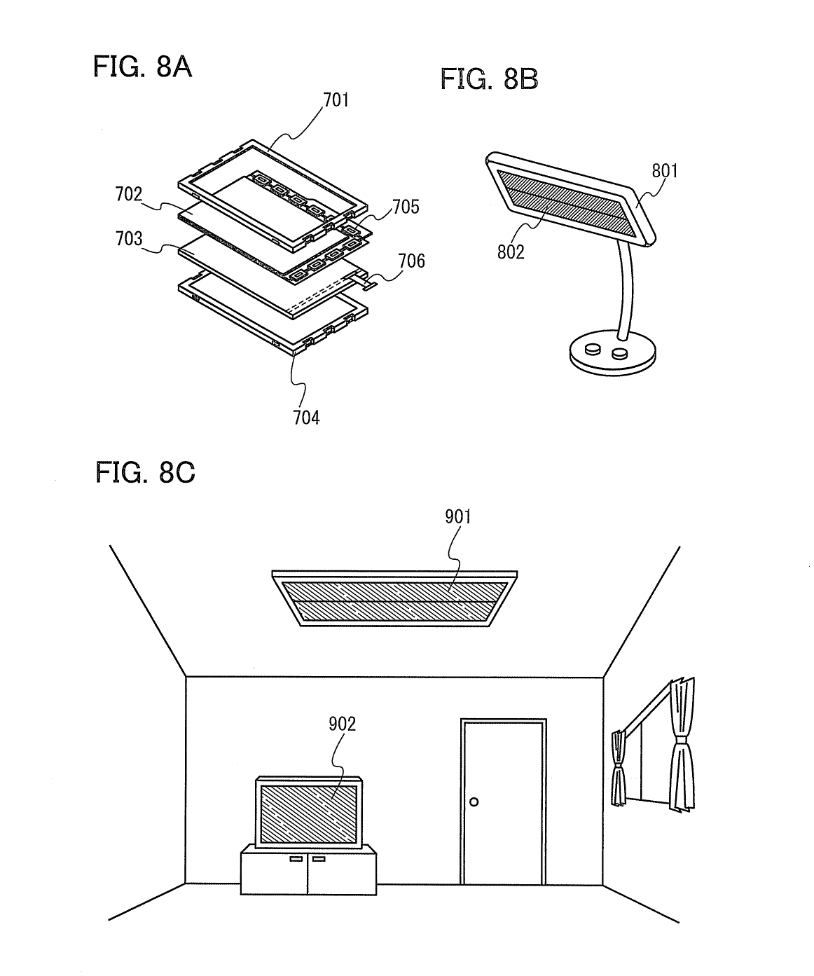

The light-emitting device according to one embodiment of the present invention can also be used as a lighting device. FIG. 8A illustrates an example of a liquid crystal display device using the light-emitting device according to one embodiment of the present invention as a backlight. The liquid crystal display device illustrated in FIG. 8A includes a housing 701, a liquid crystal layer 702, a backlight 703, and a housing 704. The liquid crystal layer 702 is connected to a driver IC 705. The light-emitting device according to one embodiment of the present invention is used as the backlight 703, and current is supplied through a terminal 706.

By using the light-emitting device according to one embodiment of the present invention as a backlight of a liquid crystal display device as described above, a backlight with low power consumption can be obtained. Moreover, since the light-emitting device according to one embodiment of the present invention is a lighting device for surface light emission and the enlargement of the light-emitting device is possible, the backlight can be made larger. Accordingly, a larger-area liquid crystal display device with low power consumption can be obtained.

Next, FIG. 8B illustrates an example in which the light-emitting device according to one embodiment of the present invention is used for a desk lamp which is a lighting device. The desk lamp illustrated in FIG. 8B has a housing 801 and a light source 802, and the light emitting device according to one embodiment of the present invention is used as the light source 802. Since the light-emitting device according to one embodiment of the present invention is driven at a low voltage and has high current efficiency, by the application of the light-emitting device according to one embodiment of the present invention, a desk lamp with reduced power consumption can be obtained.

Next, FIG. 8C illustrates an example in which the light-emitting device according to one embodiment of the present invention is used for an indoor lighting device 901. Since the light-emitting device according to one embodiment of the present invention can have a larger area, the light-emitting device according to one embodiment of the present invention can be used as a lighting system having a large area. Since the light-emitting device according to one embodiment of the present invention is driven at a low voltage and has high current efficiency, by the application of the light-emitting device according to one embodiment of the present invention, a lighting device with reduced power consumption can be obtained. In a room where the light-emitting device according to one embodiment of the present invention is used for the indoor lighting device 901 as above, a television set 902 according to one embodiment of the present invention as described referring to FIG. 6A can be installed so that public broadcasting and movies can be watched.

Note that this embodiment can be combined with any of the other embodiments, as appropriate.

### Example 1

Example 1 specifically shows, as an example, a synthetic example of a phosphorescent iridium metal complex bis{2-[6-(9H-carbazol-9-yl)-4-pyrimidinyl-κN3]phenyl-κC}(2,4-pentanedionato-κ²O,O′) iridium(III) (abbreviation: [Ir(czppm)₂(acac)]) represented by the structural formula (100) in Embodiment 1 according to one embodiment of the present, invention.

### Step 1: Synthesis of 4-carbazol-9-yl-6-phenylpyrimidine (Abbreviation: Hczppm)

First, 0.053 g of sodium hydride (60% in mineral oil) and 30 mL of dehydrated N,N-dimethylformamide (dry DMF) were put in a three-neck flask, and the air in the flask was replaced by nitrogen. Into this flask, 1.76 g of carbazole and 30 mL of dry DMF were added, and the mixture was stirred at room temperature for 1 hour. After that, 1.76 g of 4-chloro-6-phenylpyrimidine and 30 mL of dry DMF were added, and the solution was stirred at room temperature for 4 hours. After the reaction, this solution was added to water and a solid was precipitated, followed by suction-filtration. This solid was purified by flash column chromatography using dichloromethane as a developing solvent, so that the objective pyrimidine derivative Hczppm was obtained (white powder, yield of 62%). A synthetic scheme of Step 1 is shown in the following (e-1).

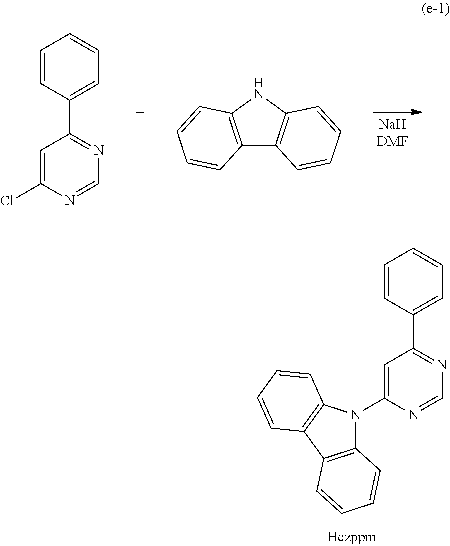 [SMILES: Clc1cc(-c2ccccc2)ncn1 ; c1ccc2c(c1)[nH]c1ccccc12 ; c1ccc(-c2cc(-n3c4ccccc4c4ccccc43)ncn2)cc1]

### Step 2: Synthesis of di-μ-chloro-tetrakis{2-[6-(9H-carbazol-9-yl)-4-pyrimidinyl-κN3]phenyl-κC}diiridium(III) (Abbreviation: [Ir(czppm)₂Cl]₂)

Next, into a recovery flask equipped with a reflux pipe, 15 mL of 2-ethoxyethanol, 5 mL of water, 1.24 g of Hczppm obtained in the above Step 1, and 0.57 g of iridium chloride hydrate (IrCl₃.H₂O) (produced by Sigma-Aldrich Co. LLC.) were put, and the air in the flask was replaced by argon. After that, irradiation with microwaves (2.45 GHz, 100 W) was performed for 1 hour to cause a reaction. The solvent was distilled off, and then the obtained residue was suction-filtered and washed with ethanol to give a dinuclear complex [Ir(czppm)₂Cl]₂ (abbreviation) (brown powder, yield of 93%). A synthetic scheme of Step 2 is shown in the following (e-2).

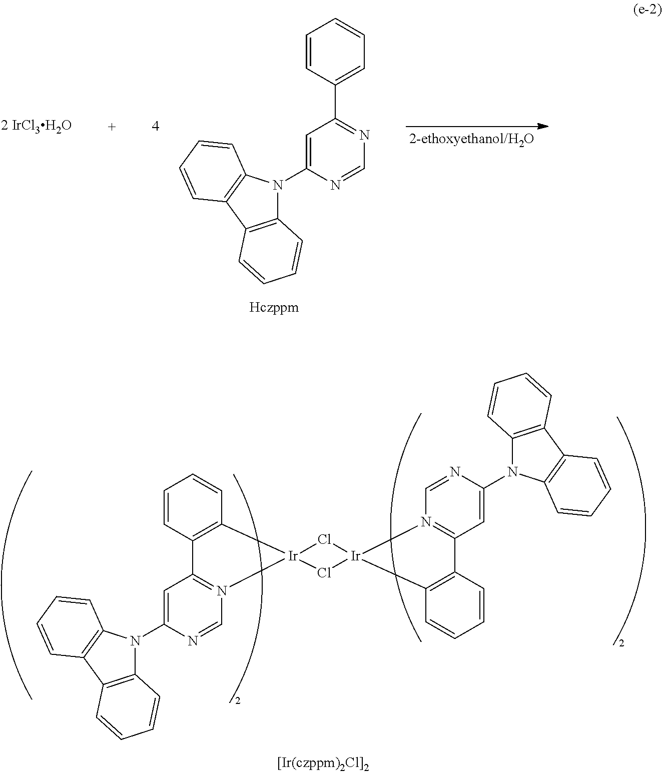

### Step 3: Synthesis of bis{2-[6-(9H-carbazol-9-yl)-4-pyrimidinyl-κN3]phenyl-κC}(2,4-pentanedionato-κ²O,O′) iridium(III) (Abbreviation: [Ir(czppm)₂(acac)])

Further, 30 mL of 2-ethoxyethanol, L54 g of the dinuclear complex [Ir(czppm)₂Cl]₂ obtained in the above Step 2, 0.27 g of acetylacetone, and 0.94 g of sodium carbonate were put into a recovery flask equipped with a reflux pipe, and the air in the flask was replaced by argon. After that, the mixture was heated by irradiation with microwaves (2.45 GHz, 120 W) for 60 minutes. Here, 0.10 g of acetylacetone was further put into the flask, and the mixture was heated again by irradiation with microwaves (2.45 GHz, 120 W) for 60 minutes. The solvent was distilled off, and the obtained residue was suction-filtered with ethanol. The obtained solid was washed with water and ethanol, and purified by flash column chromatography using dichloromethane as a developing solvent. After that, recrystallization was carried out with a mixed solvent of dichloromethane and hexane, so that the phosphorescent iridium metal complex [Ir(czppm)₂(acac)] (abbreviation) according to one embodiment of the present invention was obtained as reddish orange powder (18% in yield). A synthetic scheme of Step 3 is shown in the following (e-3).

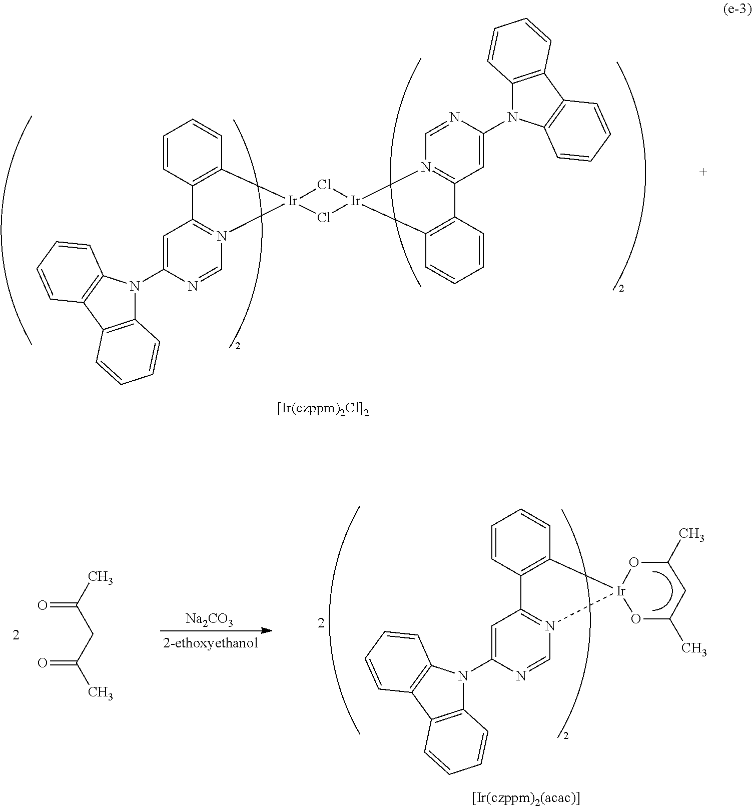

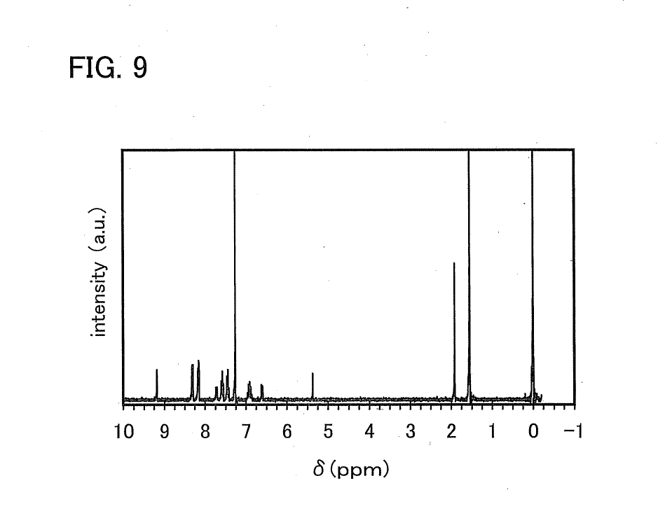

The reddish orange powder obtained in the above Step 3 was analyzed by nuclear magnetic resonance spectrometry (¹H-NMR). The ¹H-NMR chart is shown in FIG. 9. These results revealed that the phosphorescent iridium metal complex [Ir(czppm)₂(acac)] (abbreviation) represented by the structural formula (100) according to one embodiment of the present invention was obtained in this synthetic example.

¹H-NMR data of the obtained substance are as follows.

¹H-NMR. δ (CDCl₃): 1.92 (s, 6H), 5.37 (s, 1H), 6.61 (d, 2H), 6.88-6.94 (m, 4H), 7.45 (t, 4H), 7.58 (t, 4H), 7.72 (d, 2H), 8.16-8.17 (m, 6H), 8.31 (d, 4H), 9.19 (s, 2H).

Next, [Ir(czppm)₂(acac)] (abbreviation) obtained in this example was analyzed by liquid chromatography mass spectrometry (LC/MS).

In the analysis by LC/MS, liquid chromatography (LC) separation was carried out with ACQUITY UPLC (manufactured by Waters Corporation), and mass spectrometry (MS) analysis was carried out with Xevo G2 T of MS (manufactured by Waters Corporation). An ACQUITY UPLC BEH C8 column (2.1 mm×100 mm, 1.7 μm) was used in the LC separation, where the column temperature was 40° C. Acetonitrile was used for Mobile Phase A and 0.1% of a formic acid aqueous solution was used for Mobile Phase B. Further, a sample was prepared in such a manner that [Ir(czppm)(acac)] (abbreviation) was dissolved in chloroform at a given concentration and the mixture was diluted with acetonitrile. The injection amount was 5.0 μL.

In the LC separation, a gradient method in which the composition of mobile phases is changed was employed. The ratio of Mobile Phase A to Mobile Phase B was 35:65 for 0 to 1 minute after the start of the measurement, and then the composition was changed so that the ratio of Mobile Phase A to Mobile Phase B in the 10th minute was 95:5. The composition was changed linearly.

In the MS analysis, ionization was carried out by an electrospray ionization (ESI) method; the capillary voltage and the sample cone voltage were set to 3.0 kV and 30 V, respectively; detection was carried out in a positive mode. A mass range for the measurement was m/z 100-1200.

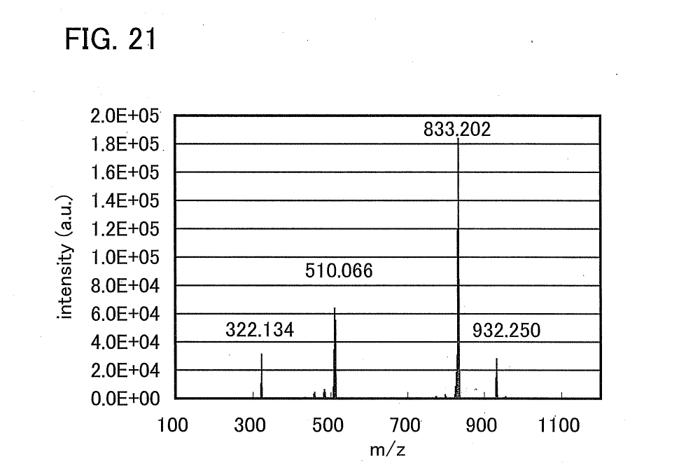

A component which underwent the ionization under the above-described conditions was collided with an argon gas in a collision cell to dissociate into product ions. Energy (collision energy) for the collision with argon was 70 eV. The results of MS analysis of the dissociated product ions by time-of-flight (ToF) mass spectrometry are shown in FIG. 21. In FIG. 21, the horizontal axis represents m/z and the vertical axis represents intensity (arbitrary unit).

The results in FIG. 21 show that as for [Ir(czppm)₂(acac)] (abbreviation) according to one embodiment of the present invention, peaks of product ions of a partial skeleton are detected mainly around m/z 322, m/z 510, and m/z 833, and a peak derived from a precursor ion is detected around m/z 932. Here, “around” is used to express changes in values of product ions and precursor ions due to the existence and absence of hydrogen ions and the existence of isotopes, and these changes in values are regarded as being in an acceptable range included in similar skeletons. The results in FIG. 21 are characteristically derived from [Ir(czppm)₂(acac)] (abbreviation) and thus can be regarded as important data in identification of [Ir(czppm)₂(acac)] (abbreviation) contained in a mixture.

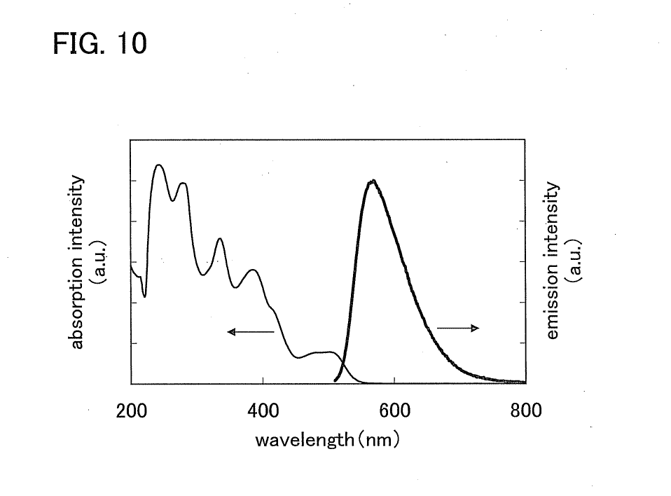

Next, an analysis of [Ir(czppm)₂(acac)] (abbreviation) was conducted by an ultraviolet-visible (UV) absorption spectrometry. The UV spectrum was measured with an ultraviolet-visible spectrophotometer (V-550, produced by JASCO Corporation) using a dichloromethane solution (0.075 mmol/L) at room temperature. Further, an emission spectrum of [Ir(czppm)₂(acac)] (abbreviation) was measured. The emission spectrum was measured with a fluorescence spectrophotometer (FS920, manufactured by Hamamatsu Photonics KK.) using a degassed dichloromethane solution (0.075 mmol/L) at room temperature. FIG. 10 shows the measurement results. In FIG. 10, the horizontal axis represents wavelength (nm), and the vertical axes represent absorption intensity (arbitrary unit) and emission intensity (arbitrary unit).

As shown in FIG. 10, as for the dichloromethane solution of the phosphorescent iridium metal complex [Ir(czppm)₂(acac)] (abbreviation) according to one embodiment of the present invention, an absorption peak from a triplet excited state was seen around 510 nm and an emission peak was seen at 569 nm. Further, orange light emission was observed from the dichloromethane solution.

These results reveal that the Stokes shill of the dichloromethane solution is small, which is 59 nm.

### Example 2

In this example, electrochemical characteristics (solution) of bis{2-[6-(9H-carbazol-9-yl)-4-pyrimidinyl-κN3]phenyl-κC}(2,4-pentanedionato-κ²O,O′) iridium(III) (abbreviation: [Ir(czppm)₂(acac)]), which was synthesized in Example 1 as a phosphorescent iridium metal complex according to one embodiment of the present invention, were measured. A structural formula of a material used in this example is shown below.

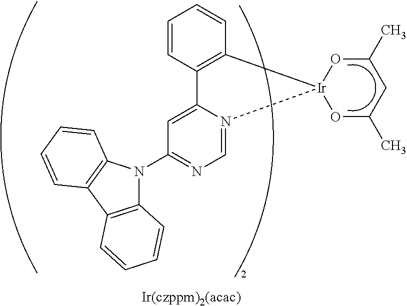

The electrochemical characteristics were examined by cyclic voltammetry (CV) measurement. Note that an electrochemical analyzer (ALS model 600A or 600C, manufactured by BAS Inc.) was used for the measurement. The method of the measurement is described in detail below.

(Calculation of the Potential Energy of the Reference Electrode with Respect to the Vacuum Level)

First, a potential energy (eV) of the reference electrode (Ag/Ag⁺ electrode), which was used in this example, with respect to the vacuum level was calculated. That is, the Fermi level of the Ag/Ag⁺ electrode was calculated. It is known that the oxidation-reduction potential of ferrocene in methanol is +0.610 [V vs. SHE] with respect to a standard hydrogen electrode (Reference: Christian R. Goldsmith et al., J. Am. Chem. Soc., Vol. 124, No. 1, pp. 83-96, 2002).

On the other hand, using the reference electrode used in this example, the oxidation-reduction potential of ferrocene in methanol was calculated to be +0.11 [V vs. Ag/Ag⁺]. Thus, it was found that the potential energy of the reference electrode used in this example was lower than that of the standard hydrogen electrode by 0.50 [eV].

Here, it is known that the potential energy of the standard hydrogen electrode with respect to the vacuum level is −4.44 eV (Reference: Toshihiro Ohnishi and Tamami Koyama, High molecular EL material, Kyoritsu shuppan, pp. 64-67). Accordingly, the potential energy of the reference electrode, which was used in this example, with respect to the vacuum level could be calculated as follows: −4.44−0.50=−4.94 [eV].

### (CV Measurement of the Objective Substance)

As for a solution used for the CV measurement, dehydrated dimethylformamide (DMF, product of Sigma-Aldrich Co. LLC., 99.8%, catalog No. 22705-6) was used as a solvent, and tetra-n-butylammonium perchlorate (n-Bu₄NClO₄, product of Tokyo Chemical Industry Co., Ltd., catalog No. T0836), which was a supporting electrolyte, was dissolved in the solvent such that the concentration of tetra-n-butylammonium perchlorate was 100 mmol/L. Further, the object to be measured was dissolved in the solvent such that the concentration thereof was 2 mmol/L. A platinum electrode (manufactured by BAS Inc., PTE platinum electrode) was used as a working electrode, a platinum electrode (manufactured by BAS Inc., Pt counter electrode for VC-3, (5 cm)) was used as an auxiliary electrode, and an Ag/Ag⁺ electrode (manufactured by BAS Inc., RE-7 reference electrode for nonaqueous solvent) was used as a reference electrode. Note that the measurement was conducted at room temperature (20° C. to 25° C.). In addition, the scan rate at the CV measurement was set to 0.1 V/sec in all the measurement.

This solution was used to carry out the CV measurement of the objective substance. The potential of the working electrode with respect to the reference electrode was scanned from 0 V to 1.5 V, whereby a distinct peak indicating oxidation was observed. The shape of the peak did not greatly change even after 100 scan cycles. This indicates that [Ir(czppm)₂(acac)] (abbreviation) has properties effective against repetition of redox reactions between an oxidized state and a neutral state.

Note that in this CV measurement, the oxidation peak potential (from the neutral state to the oxidation state) Eₚₐ was 0.65 V. In addition, the reduction peak potential (from the oxidation side to the neutral state) E_{pc} was 0.55 V. Therefore, the half-wave potential (potential intermediate between Eₚₐ and E_{pc}, (Eₚₐ+E_{pc})/2 [V]) can be calculated to be 0.60 V. This shows that [Ir(czppm)₂(acac)] (abbreviation) is oxidized by an electrical energy of 0.60 [V vs. Ag/Ag⁺]. Here, since the potential energy of the reference electrode, which was used above, with respect to the vacuum level was −4.94 [eV] as described above, the HOMO level of [Ir(czppm)₂(acac)] (abbreviation) was calculated as follows: −4.94−0.60=−5.54 [eV].

### Example 3

In this example, a light-emitting element 1 in which bis{2-[6-(9H-carbazol-9-yl)-4-pyrimidinyl-κN3]phenyl-κC}(2,4-pentanedionato-κ²O,O′) iridium(III) (abbreviation: [Ir(czppm)₂(acac)]), which was synthesized in Example 1, was used as a light-emitting material was evaluated. Chemical formulas of materials used in this example are shown below.

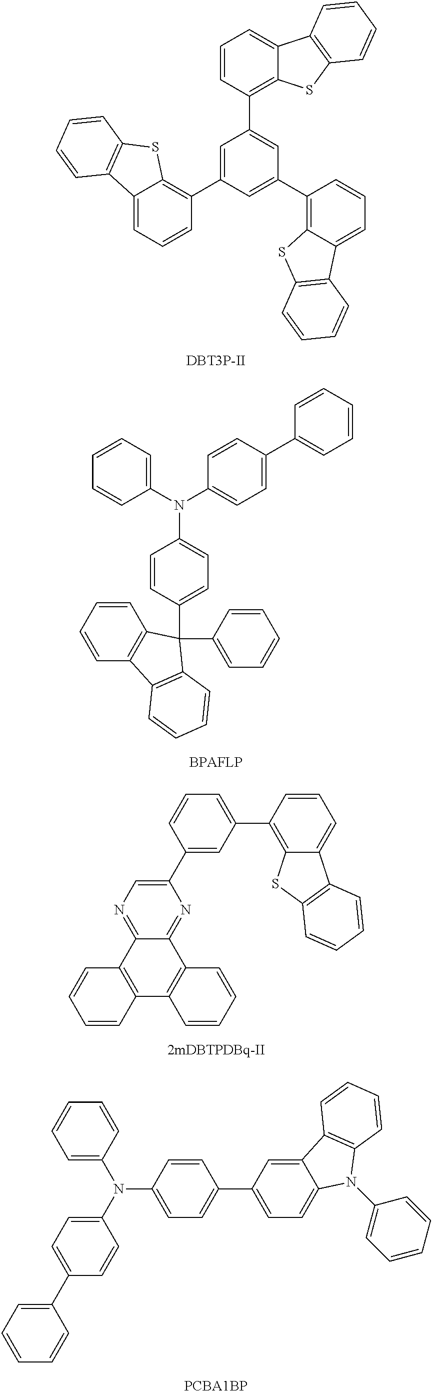 [SMILES: c1ccc2c(c1)sc1c(-c3cc(-c4cccc5c4sc4ccccc45)cc(-c4cccc5c4sc4ccccc45)c3)cccc12 ; c1ccc(-c2ccc(N(c3ccccc3)c3ccc(C4(c5ccccc5)c5ccccc5-c5ccccc54)cc3)cc2)cc1 ; "DBT3P-II" ; c1cc(-c2cnc3c4ccccc4c4ccccc4c3n2)cc(-c2cccc3c2sc2ccccc23)c1 ; c1ccc(-c2ccc(N(c3ccccc3)c3ccc(-c4ccc5c(c4)c4ccccc4n5-c4ccccc4)cc3)cc2)cc1]

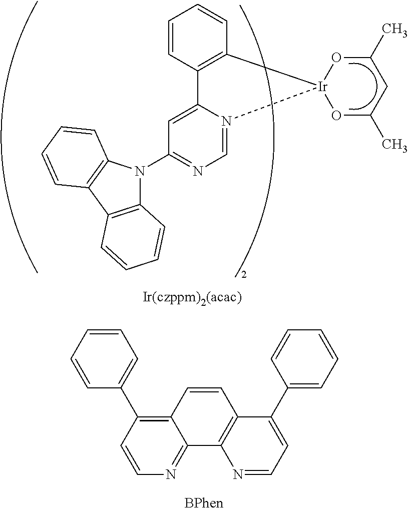

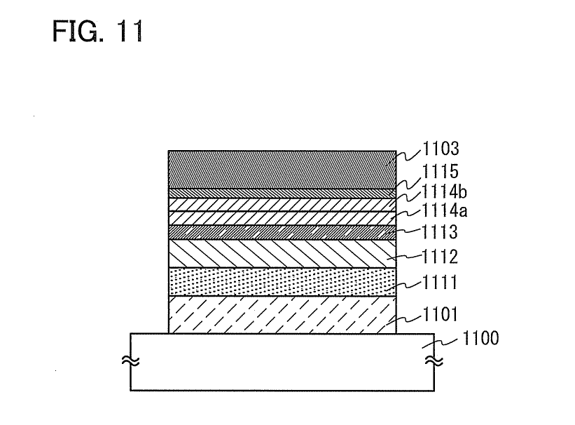

The light-emitting element 1 is described with reference to FIG. 11. The following shows a method for manufacturing the light-emitting element 1 of this example.

### (Light-Emitting Element 1)

First, an indium oxide-tin oxide compound containing silicon or silicon oxide (ITO-SiO₂, hereinafter abbreviated to ITSO) was deposited by a sputtering method over a substrate 1100, so that a first electrode 1101 was formed. Note that the composition ratio of In₂O₃ to SnO₂ and SiO₂ in the indium oxide-tin oxide compound target used was 85:10:5 [wt %]. The thickness of the first electrode 1101 was 110 nm and the electrode area was 2 min×2 mm. Here, the first electrode 1101 is an electrode that functions as an anode of the light-emitting element.

Next, as pretreatment for forming the light-emitting element over the substrate 1100, the surface of the substrate was washed with water, baked at 200° C. for 1 hour, and subjected to UV ozone treatment for 370 seconds.

After that, the substrate 1100 was transferred into a vacuum evaporation apparatus where the pressure had been reduced to approximately 10⁻⁴ Pa, and subjected to vacuum baking at 170° C. for 30 minutes in a heating chamber of the vacuum evaporation apparatus, and then the substrate 1100 was cooled down for about 30 minutes.

Next, the substrate 1100 provided with the first electrode 1101 was fixed to a substrate holder in the vacuum evaporation apparatus such that a surface on which the first electrode 1101 was provided faced downward. The pressure in the vacuum evaporation apparatus was reduced to about 10⁻⁴ Pa. After that, over the first electrode 1101, 1,3,5-tri(dibenzothiophen-4-yl)-benzene (abbreviation: DBT3P-II) and molybdenum oxide were co-evaporated, so that a hole-injection layer 1111 was formed. The thickness of the hole-injection layer 1111 was set to 40 nm, and the weight ratio of DBT3P-II (abbreviation) to molybdenum oxide was adjusted to 4:2 (=DBT3P-II:molybdenum oxide). Note that the co-evaporation refers to an evaporation method in which evaporation is carried out from a plurality of evaporation sources at the same time in one treatment chamber.

Next, 4-phenyl-4′-(9-phenylfluoren-9-yl)triphenylamine (abbreviation: BPAFLP) was deposited to a thickness of 20 nm over the hole-injection layer 1111, so that a hole-transport layer 1112 was formed.

Further, 2-[3-(dibenzothiophen-4-yl)phenyl]dibenzo[f,h]quinoxaline (abbreviation: 2mDBTPDBq-II), 4-phenyl-4′-(9-phenyl-9H-carbazol-3-yl)triphenylamine (abbreviation: PCBA1BP), and bis{2-[6-(9H-carbazol-9-yl)-4-pyrimidinyl-κN3]phenyl-κC}(2,4-pentanedionato-κ²O,O′) iridium(III) (abbreviation; [Ir(czppm)₂(acac)]) synthesized in Example 1 were co-evaporated to form a light-emitting layer 1113 over the hole-transport layer 1112. The weight ratio of 2mDBTPDBq-II (abbreviation) to PCBA1BP (abbreviation) and [Ir(czppm)₂(acac)] (abbreviation) was adjusted to 0.8:0.2:0.05 (=2mDBTPDBq-II:PCBA1BP:[Ir(czppm)₂(acac)]). The thickness of the light-emitting layer 1113 was set to 40 nm.

Next, 2mDBTPDBq-II (abbreviation) was deposited to a thickness of 10 nm over the light-emitting layer 1113, so that a first electron-transport layer 1114a was formed.

After that, bathophenanthroline (abbreviation: BPhen) was deposited to a thickness of 20 nm over the first electron-transport layer 1114a, so that a second electron-transport layer 1114b was formed.

Further, lithium fluoride (LiF) was evaporated to a thickness of 1 nm over the second electron-transport layer 1114b by evaporation, so that an electron-injection layer 1115 was formed.

Lastly, aluminum was evaporated to a thickness of 200 nm to form a second electrode 1103 functioning as a cathode. Thus, the light-emitting element 1 of this example was fabricated.

Table 1 shows an element structure of the light-emitting element 1 obtained as described above.

TABLE 1

| | | Hole- | Hole- | | | | Electron- | |
|---|---|---|---|---|---|---|---|---|
| | First | injection | transport | Light-emitting | 1st electron- | 2nd electron- | injection | Second |
| | electrode | layer | layer | layer | transport layer | transport layer | layer | electrode |
| Light- | ITSO | DBT3P-II:MoOx | BPAFLP | 2mDBTPDBq- | 2mDBTPDBq-II | BPhen | LiF | A1 |
| emitting | 110 nm | (=4:2) | 20 nm | II:PCBA1BP:Ir (czppm)₂(acac) | 10 nm | 20 nm | 1 nm | 200 nm |
| element 1 | | 40 nm | | (=0.8:0.2:0.05) 40 nm | | | | |

The light-emitting element 1 obtained as described above was sealed in a glove box containing a nitrogen atmosphere so as not to be exposed to the air (specifically, a sealant was applied onto an outer edge of the element and heat treatment was performed at 80° C. for 1 hour at the time of sealing). Then, the operating characteristics of the light-emitting element 1 were measured. Note that the measurement was carried out at room temperature (in an atmosphere kept at 25° C.).

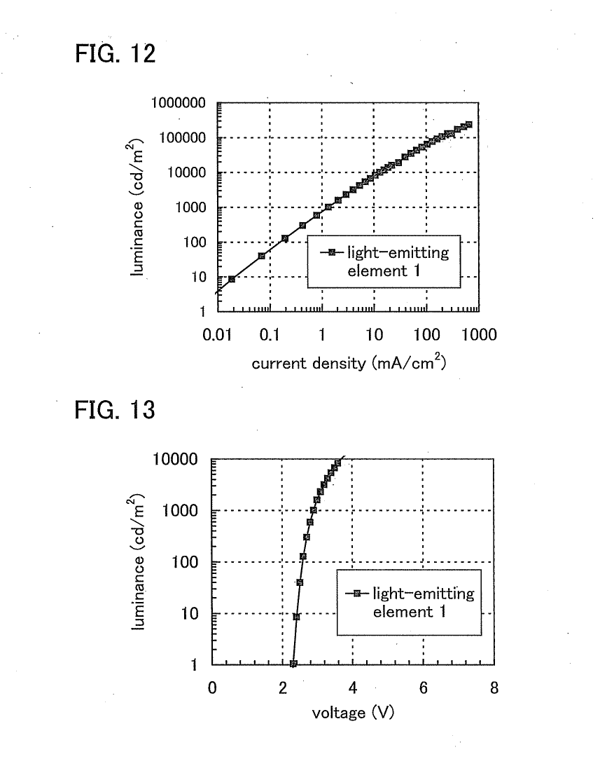

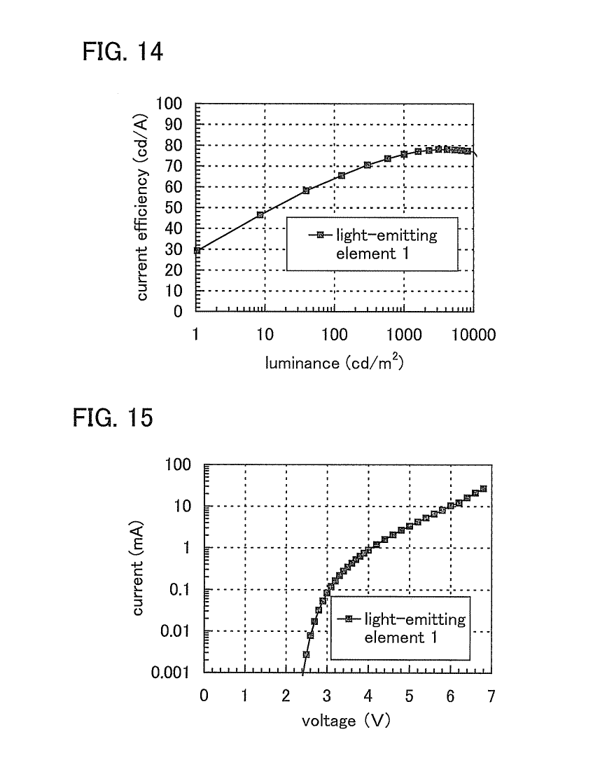

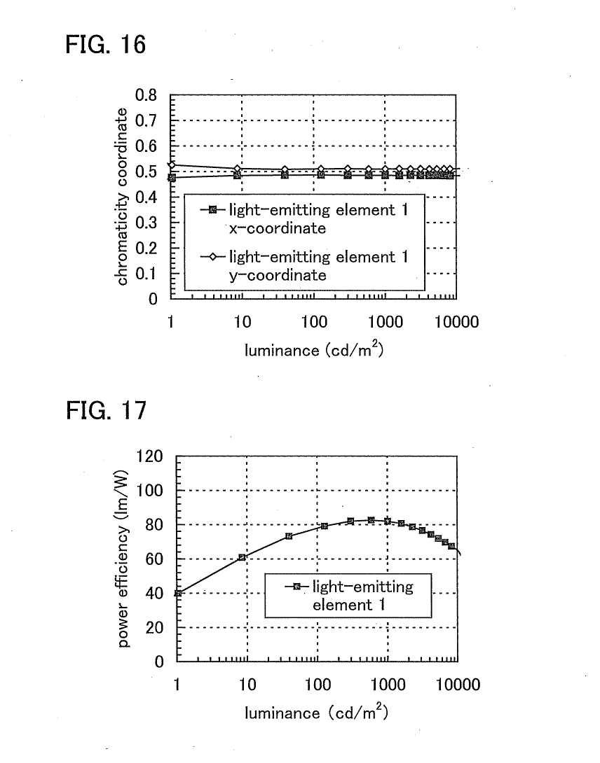

FIG. 12 shows current density versus luminance characteristics of the light-emitting element 1. In FIG. 12, the horizontal axis represents current density (mA/cm²) and the vertical axis represents luminance (cd/m²). FIG. 13 shows voltage versus luminance characteristics of the light-emitting element 1. In FIG. 13, the horizontal axis represents voltage (V) and the vertical axis represents luminance (cd/m²). FIG. 14 shows luminance versus current efficiency characteristics of the light-emitting element 1. In FIG. 14, the horizontal axis represents luminance (cd/m²) and the vertical axis represents current efficiency (cd/A). FIG. 15 shows voltage versus current characteristics of the light-emitting element 1. In FIG. 15, the horizontal axis represents voltage (V) and the vertical axis represents current (mA). FIG. 16 shows luminance versus chromaticity coordinate characteristics of the light-emitting element 1. In FIG. 16, the horizontal axis represents luminance (cd/m²) and the vertical axis represents chromaticity coordinates (x-coordinate and y-coordinate). FIG. 17 shows luminance versus power efficiency characteristics of the light-emitting element 1. In FIG. 17, the horizontal axis represents luminance (cd/m²) and the vertical axis represents power efficiency (lm/W).

Further, Table 2 shows voltage (V), current density (mA/cm²), CIE chromaticity coordinates (chromaticity x, chromaticity y), luminance (cd/m²), current efficiency (cd/A), and external quantum efficiency (%) of the light-emitting element 1 at a luminance of around 1000 cd/m².

TABLE 2

| | | Current | | | | | External |
|---|---|---|---|---|---|---|---|
| | Volt- | density | | | Lumi- | Current | emission |
| | age | (mA/ | Chromaticity | | nance | efficiency | efficiency |
| | (V) | cm²) | (x, y) | | (cd/m²) | (cd/A) | (%) |
| Light- | 2.9 | 1.3 | 0.48 | 0.51 | 1011 | 76 | 23 |
| emitting | | | | | | | |
| element | | | | | | | |
| 1 | | | | | | | |

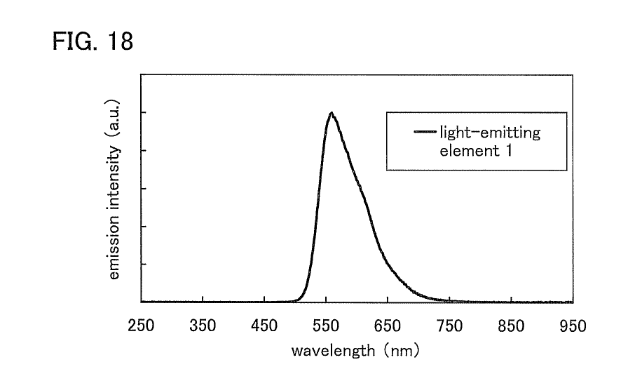

FIG. 18 shows an emission spectrum at a current density of the light-emitting element 1 of 2.5 mA/cm². In FIG. 18, the horizontal axis represents wavelength (inn) and the vertical axis represents emission intensity (arbitrary unit). As shown in FIG. 18, the emission spectrum of the light-emitting element 1 has a peak at 560 nm.

In addition, as shown in Table 2, the CIE chromaticity coordinates of the light-emitting element 1 were (x, y)=(0.48, 0.51) at a luminance of 1011 cd/m².

These results show that light originating from [Ir(czppm)₂(acac)] (abbreviation), which is the dopant, was obtained.

From the above, it is found that the light-emitting element 1 according to one embodiment of the present invention, in which [Ir(czppm)₂(acac)] (abbreviation) synthesized in Example 1 is used as the light-emitting material, can emit light in a yellow green to orange wavelength range efficiently.

FIG. 14 shows that the light-emitting element 1 has high efficiency. Further, FIG. 15 shows that the light-emitting element 1 is driven at a low voltage. Furthermore, FIG. 16 shows that the light-emitting element 1 has favorable carrier balance at any luminance.

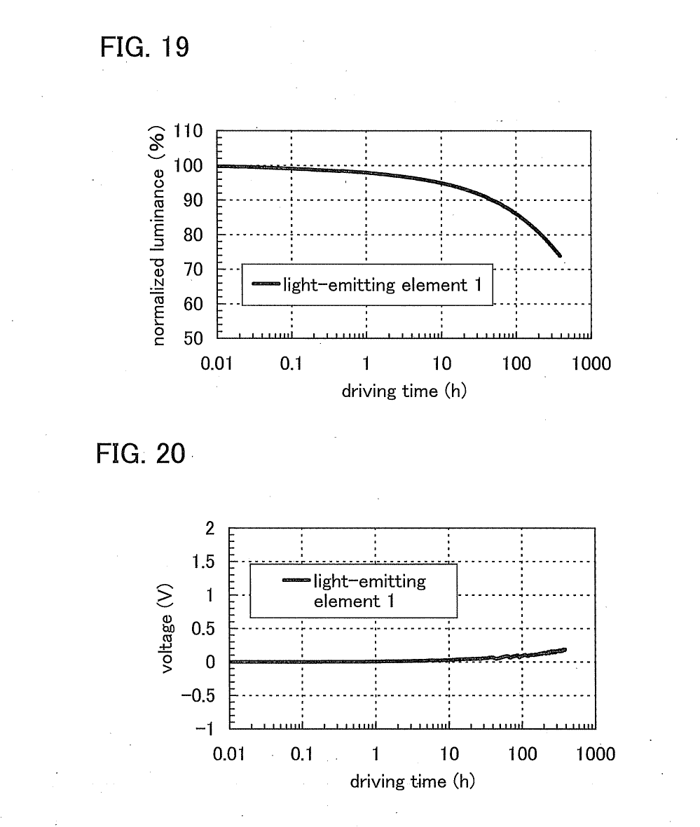

Next, a reliability test was performed on the light-emitting element 1. Results of the reliability test are shown in FIG. 19 and FIG. 20.

In the reliability test for FIG. 19, the light-emitting element 1 was driven under the conditions where the initial luminance was 5000 cd/m² and the current density was constant. The horizontal axis represents driving time (h) of the element, and the vertical axis represents normalized luminance (%) on the assumption that an initial luminance is 100%. FIG. 19 shows that the normalized luminance of the light-emitting element 1 became 80% or lower after about 217 hours. Therefore, the light-emitting element 1 is found to have a long lifetime.

Next, in the reliability test for FIG. 20, a change in voltage of the light-emitting element 1 over time was measured under the conditions where the initial luminance was 5000 cd/m² and the current density was constant. The horizontal axis represents driving time (h) of the element, and the vertical axis represents voltage (V). From FIG. 20, it is confirmed that voltage rise of the light-emitting element 1 over time is small.

From the above results, the light-emitting element 1 in which the phosphorescent iridium metal complex according to one embodiment of the present invention is used as the light-emitting material is found to have high efficiency, a low driving voltage, low power consumption, and a long lifetime.

This application is based on Japanese Patent Application serial no. 2011-222024 filed with Japan Patent Office on Oct. 6, 2011, the entire contents of which are hereby incorporated by reference.

What is claimed is:

1. A light-emitting element comprising an EL layer between a pair of electrodes, the EL layer comprising a phosphorescent iridium metal complex,
wherein in the phosphorescent iridium metal complex:
nitrogen at a 3-position of a pyrimidine ring having an aryl group bonded to a 4-position of the pyrimidine ring is coordinated to iridium,
a substituent having a carbazole skeleton is bonded to a 6-position of the pyrimidine ring, and
the aryl group bonded to the 4-position of the pyrimidine ring is ortho-metalated by being bonded to the iridium.

2. The light-emitting element according to claim 1,
wherein the phosphorescent iridium metal complex includes a structure represented by a general formula (G1-1): 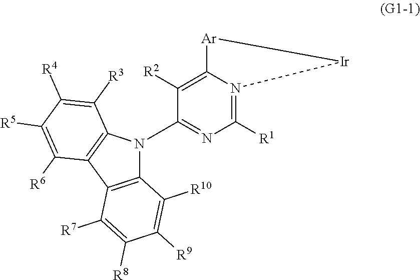
and
wherein:
Ar represents a substituted or unsubstituted arylene group having 6 to 13 carbon atoms,
R¹ and R² separately represent hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

3. The light-emitting element according to claim 1,
wherein the phosphorescent iridium metal complex is represented by a general formula (G1-2): 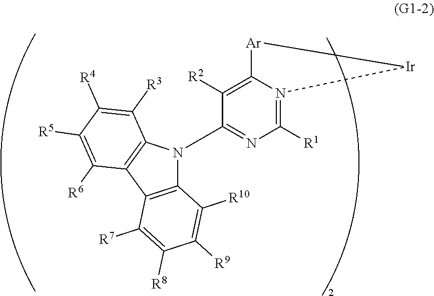
and
wherein:
Ar represents a substituted or unsubstituted arylene group having 6 to 13 carbon atoms,
R¹ and R² separately represent hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

4. The light-emitting element according to claim 1,
wherein the phosphorescent iridium metal complex is represented by a general formula (G1-3): 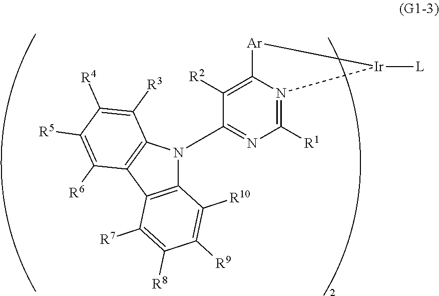
and
wherein:
Ar represents a substituted or unsubstituted arylene group having 6 to 13 carbon atoms,
R¹ and R² separately represent hydrogen or an alkyl group having 1 to 4 carbon atoms,
R³ to R¹⁰ separately represent hydrogen, an alkyl group having 1 to 4 carbon atoms, or a substituted or unsubstituted phenyl group, and
L represents a monoanionic ligand.

5. A light-emitting device comprising the light-emitting element according to claim 1.

6. An electronic appliance comprising the light-emitting element according to claim 1.

7. A lighting device comprising the light-emitting element according to claim 1.

8. A light-emitting element comprising an EL layer between a pair of electrodes, the EL layer comprising a phosphorescent iridium metal complex,
wherein in the phosphorescent iridium metal complex:
nitrogen at a 1-position of a pyrimidine ring having an aryl group bonded to a 2-position of the pyrimidine ring is coordinated to iridium,
a substituent having a carbazole skeleton is bonded to a 4-position of the pyrimidine ring, and
the aryl group bonded to the 2-position of the pyrimidine ring is ortho-metalated by being bonded to the iridium.

9. The light-emitting element according to claim 8,
wherein the phosphorescent iridium metal complex comprises a structure represented by a general formula (G2-1): 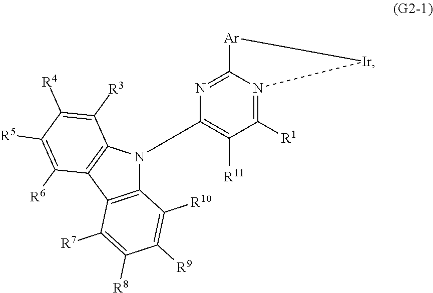
and
wherein:
Ar represents a substituted or unsubstituted arylene group having 6 to 13 carbon atoms,
R¹ and R¹¹ separately represent hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

10. The light-emitting element according to claim 8,
wherein the phosphorescent iridium metal complex is represented by a general formula (G2-2): 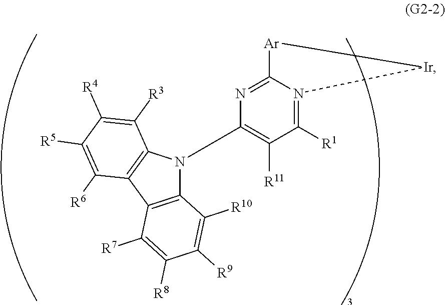
and
wherein:
Ar represents a substituted or unsubstituted arylene group having 6 to 13 carbon atoms,
R¹ and R¹¹ separately represent hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

11. The light-emitting element according to claim 8,
wherein the phosphorescent iridium metal complex is represented by a general formula (G2-3): 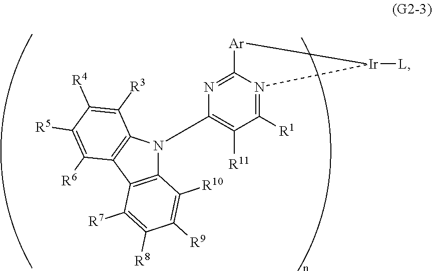
and
wherein:
Ar represents a substituted or unsubstituted arylene group having 6 to 13 carbon atoms,
R¹ and R¹¹ separately represent hydrogen or an alkyl group having 1 to 4 carbon atoms,
R³ to R¹⁰ separately represent hydrogen, an alkyl group having 1 to 4 carbon atoms, or a substituted or unsubstituted phenyl group, and
L represents a monoanionic ligand.

12. A light-emitting device comprising the light-emitting element according to claim 8.

13. An electronic appliance comprising the light-emitting element according to claim 8.

14. A lighting device comprising the light-emitting element according to claim 8.

15. A light-emitting element comprising an EL layer between a pair of electrodes, the EL layer comprising a phosphorescent iridium metal complex,
wherein in the phosphorescent iridium metal complex:
nitrogen at a 1-position of a 1,3,5-triazine ring having an aryl group bonded to a 2-position of the 1,3,5-triazine ring is coordinated to iridium,
a substituent having a carbazole skeleton is bonded to a 4-position of the 1,3,5-triazine ring, and
the aryl group bonded to the 2-position of the 1,3,5-triazine ring is ortho-metalated by being bonded to the iridium.

16. The light-emitting element according to claim 15,
wherein the phosphorescent iridium metal complex comprises a structure represented by a general formula (G3-1): 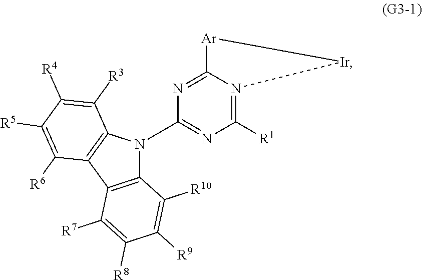
and
wherein:
Ar represents a substituted or unsubstituted arylene group having 6 to 13 carbon atoms,
R¹ represents hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

17. The light-emitting element according to claim 15,
wherein the phosphorescent iridium metal complex is represented by a general formula (G3-2): 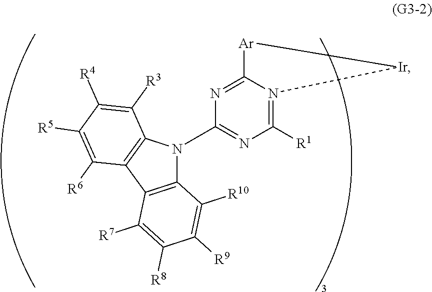
and
wherein:
Ar represents a substituted or unsubstituted arylene group having 6 to 13 carbon atoms,
R¹ represents hydrogen or an alkyl group having 1 to 4 carbon atoms, and
R³ to R¹⁰ separately represent hydrogen, an alkyl group having 1 to 4 carbon atoms, or a substituted or unsubstituted phenyl group.

18. The light-emitting element according to claim 15,
wherein the phosphorescent iridium metal complex is represented by a general formula (G3-3): 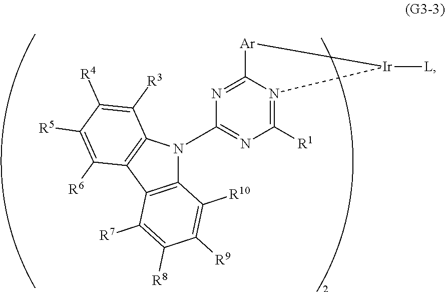
and
wherein:
Ar represents a substituted or unsubstituted arylene group having 6 to 13 carbon atoms,
R¹ represents hydrogen or an alkyl group having 1 to 4 carbon atoms,
R³ to R¹⁰ separately represent hydrogen, an alkyl group having 1 to 4 carbon atoms, or a substituted or unsubstituted phenyl group, and
L represents a monoanionic ligand.

19. A light-emitting device comprising the light-emitting element according to claim 15.

20. An electronic appliance comprising the light-emitting element according to claim 15.

21. A lighting device comprising the light-emitting element according to claim 15.

22. A phosphorescent iridium metal complex represented by one selected from the group consisting of general formulas (G1-2), (G1-3), (G2-2), (G2-3), (G3-2) and (G3-3) and a structural formula (100): 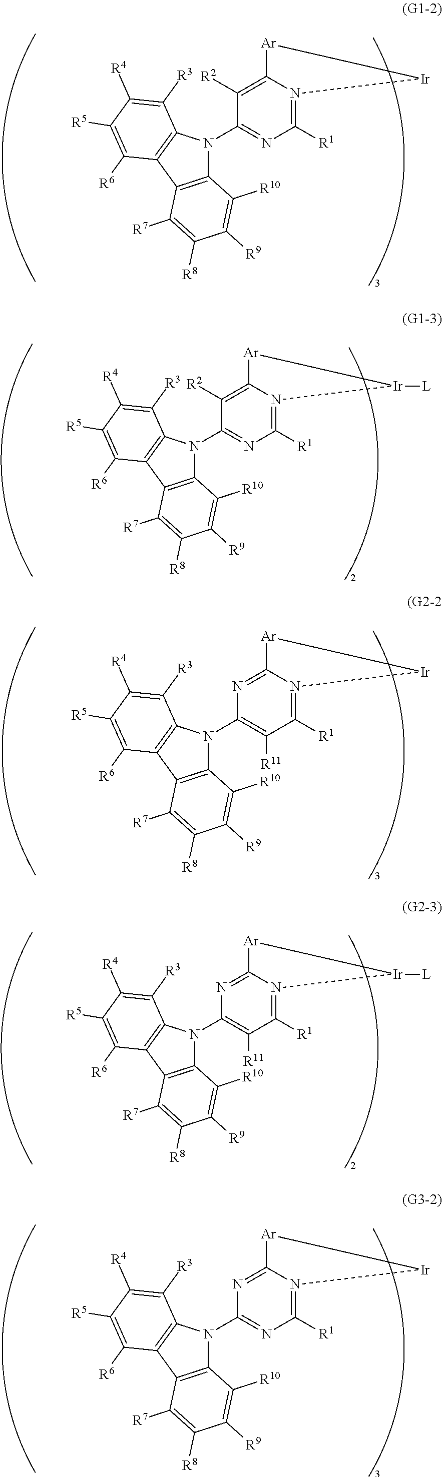 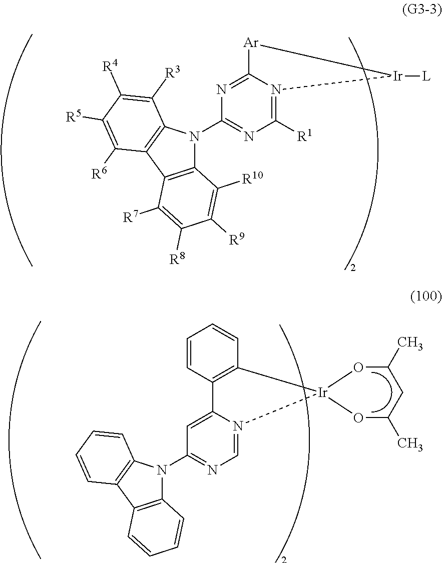
wherein:
Ar represents a substituted or unsubstituted arylene group having 6 to 13 carbon atoms,
R¹, R² and R¹¹ separately represent hydrogen or an alkyl group having 1 to 4 carbon atoms,
R³ to R¹⁰ separately represent hydrogen, an alkyl group having 1 to 4 carbon atoms, or a substituted or unsubstituted phenyl group, and
L represents a monoanionic ligand.
